(19) United States
(12) Patent Application Publication
(10) Pub. No.: US 2008/0031549 A1
(43) Pub. Date: Feb. 7, 2008

(54) Image processing apparatus, image reading apparatus, image forming apparatus, image processing method, and recording medium

(75) Inventors: Yohsuke Konishi, Nara-shi (JP); Masakazu Ohira, Shiki-gun (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/882,541

(22) Filed: Aug. 2, 2007

(30) Foreign Application Priority Data
Aug. 3, 2006 (JP) 2006-212348
Oct. 12, 2006 (JP) 2006-278954

(51) Int. Cl. G06K 9/60

(52) U.S. Cl. 382/305

(57) ABSTRACT

An image processing apparatus includes a feature point calculating section for calculating a feature point in an input image, a features calculating section for calculating features remaining unchanged during the movement, inclination, and rotation of the image, a vote processing section for voting for a preliminarily stored format in reference to the feature quantity, a similarity determiner for determining the similarity between the input image and the stored format from the result of the voting, a written region extractor for, when the similarity is determined, extracting a written-in region in the stored format from the input image, and a registration controller for controlling the registration to an image data storage.

### CROSS-REFERENCE TO RELATED APPLICATIONS

This Nonprovisional application claims priority under 35 U.S.C. §119(a) on Patent Application No. 2006-212348 and No. 2006-278954 filed in Japan on Aug. 3, 2006 and Oct. 12, 2006 respectively, the entire contents of which are hereby incorporated by reference.

### BACKGROUND

1. Technical Field

The present invention relates to an image processing apparatus, an image reading apparatus, an image forming apparatus, an image processing method, and a recording medium including a unit for storing an image of a specific format.

2. Description of the Related Art

There have been proposed various filing apparatuses and methods for picking up characters, character string frames, or frames from an input image and matching each frame with frame data to identify its format stably thereby reducing tasks of a user for processing files (as disclosed in, for example, Japanese Patent Application Laid-Open No. 08-255236).

However, the conventional filing apparatus disclosed in Japanese Patent Application Laid-Open No. 08-255236 operates such that while each file of a registered format is edited through providing a file name and cutting out a desired portion of an image, its entirety including common portion such as the registered format has to be filed or saved when carrying out the filing, and thus the storage size to be used for the saving is increased.

### SUMMARY

The present invention has been made in view of the foregoing circumstances and its object is to provide an image processing apparatus, an image reading apparatus, an image forming apparatus, an image processing method, and a recording medium which are capable of extracting an image of a line (a rule) and an image of a character separately from an original image to be stored, when the extracted line is of a specific format, correlating the extracted character with the specific format of the extracted line and saving the same, and when the extracted line is not of the specific format, saving the extracted line, whereby the memory size required for filing or saving a ledger sheet, etc. can be reduced.

An image processing apparatus according to the present invention includes: an image input unit for receiving an image; an image storage unit for storing the image; a similarity determining unit for determining similarity between an input image received from the image input unit and a stored image stored in the image storage unit; and a region extracting unit for, when it is determined that the input image is similar to the stored image, examining whether or not the input image is equal to the stored image added with written data and extracting a region containing the written data from the input image, wherein an image of the region extracted by the region extracting unit is stored in the image storage unit.

According to the present invention, when it is determined that the input image is equal to the stored image added with written data, the region containing the written data is extracted from the input image and stored in the image storage unit, whereby a variety of written images can be stored together with a desired format such as a format including mainly characters or a format including characters and lines which is common to the images.

The image processing apparatus according to the present invention may be modified in which, when two or more of the regions have been extracted, an image of each of the extracted regions is stored in the image storage unit.

Accordingly, when two or more of the regions containing the written data are extracted, they are stored on the region-by-region basis in the image storage unit. This allows a combination of the written image and the format to be edited for, for example, inhibiting the output of a desired portion.

The image processing apparatus according to the present invention may be modified in which the image to be stored in the image storage unit is encoded.

Accordingly, as the image to be stored is encoded, the memory size of the storage unit can be minimized.

The image processing apparatus according to the present invention may be modified in which the image stored in the encoded form in the image storage unit is decoded and the decoded images are combined.

Accordingly, as the images stored in the encoded form are decoded and combined, the data can be used for printing texts in a specific format such as a ledger sheet.

An image processing apparatus according to the present invention includes: an image input unit for receiving an image; an extracting unit for extracting an image of lines and an image of characters separately from the input image received from the image input unit; and a deciding unit for deciding whether or not the lines extracted by the extracting unit are of a specific format, wherein when the deciding unit decides that the extracted lines are of the specific format, the extracted characters are correlated with the specific format of the extracted lines and stored in a storage and, when the deciding unit decides that the extracted lines are not of the specific format, the extracted lines are stored in the storage.

Accordingly, the lines and the characters are extracted separately from the input image and when the extracted lines are of the specific format, the extracted characters are correlated with the specific format of the extracted lines and stored in the storage. This prevents the image of the lines from being stored redundantly. When the extracted lines are not of the specific format, they are stored in the storage. This allows the stored lines of another format to be used as a reference for the determination when a new input image is received.

The image processing apparatus according to the present invention may be modified in which when it is decided that the extracted lines are not of the specific format, the extracted characters are correlated with the extracted lines and stored in the storage.

Accordingly, when the extracted lines are not of the specific format, the lines and the characters are correlated to each other and stored in the storage.

The image processing apparatus according to the present invention may be modified in which the extracted lines and the characters are encoded and stored in the storage.

Accordingly, as the extracted lines and the extracted characters are encoded before stored, the storage can be minimized in the memory size used for the filing process. In particular, the encoding ratio can be improved by encoding the extracted lines and the extracted characters separately, hence significantly reducing the memory size of the storage for the filing process.

The image processing apparatus according to the present invention may be modified in which the lines and the characters encoded and stored in the storage are decoded and then combined.

Accordingly, as the lines and the characters encoded and stored in the storage are decoded and combined, the data can be used for printing texts in a specific format such as a ledger sheet.

An image reading apparatus according to the present invention includes: an image reading unit for reading an image from a document; and the image processing apparatus described above, wherein the image read by the image reading unit is processed in the image processing apparatus.

Accordingly, the image reading apparatus can be implemented in the form of a scanner for recording and storing images.

An image forming apparatus according to the present invention includes: the image processing apparatus described above; and an image forming unit for forming on a sheet a composite image produced by the image processing apparatus.

Accordingly, as the lines and the characters stored in association with each other are combined and printed on a sheet, the data can be used for producing a print such as a ledger sheet.

A method of processing images according to the present invention includes the steps of determining similarity between an input image and a stored image; when it is determined that the input image is similar to the stored image, determining whether or not the input image is equal to the stored image added with written data; when it is determined that the input image is equal to the stored image added with the written data, extracting a region containing the written data from the input image; and storing an image of the extracted region in a storage.

Accordingly, when it is determined that the input image is equal to the stored image added with written data, a region containing the written data is extracted and the image thereof is stored in the storage. This allows a desired format, such as a format including mainly characters or a format including characters and lines, to be provided for common use and filled with the written data, and stored as a new image.

A method of processing images according to the present invention includes the steps of extracting an image of lines and an image of characters separately from the input image; deciding whether or not the extracted lines are of a specific format; when it is decided that the extracted lines are of the specific format, correlating the extracted characters with the specific format of the extracted lines and storing the same in a storage; and when it is decided that the extracted lines are not of the specific format, storing the extracted lines in the storage.

Accordingly, the lines and the characters are extracted separately from the input image and when the extracted lines are of the specific format, the extracted characters are correlated with the specific format of the extracted lines and stored in the storage. This prevents the image of the lines from being stored redundantly. When the extracted lines are not of the specific format, they are stored in the storage. This allows the stored lines of another format to be used as a reference for the determination when a new input image is received.

A recording medium according to the present invention is provided for storing thereon a computer program executable to perform the steps of determining similarity between an input image and a stored image; when it is determined that the input image is similar to the stored image, determining whether or not the input image is equal to the stored image added with written data; when it is determined that the input image is equal to the stored image added with the written data, extracting a region containing the written data from the input image; and storing an image of the extracted region in a storage.

Accordingly, the computer is operable to, when it is determined that the input image is equal to the stored image added with written data, extract a region containing the written data from the input image and stored the image thereof in the storage. This allows a desired format, such as a format including mainly characters or a format including characters and lines, to be provided for common use and filled with the written data, and stored as a new image.

A recording medium according to the present invention is provided for storing thereon a computer program executable to perform the steps of extracting an image of lines and an image of characters separately from the input image; deciding whether or not the extracted lines are of a specific format; when it is decided that the extracted lines are of the specific format, correlating the extracted characters with the specific format of the extracted lines and storing the same in a storage; and when it is decided that the extracted lines are not of the specific format, storing the extracted lines in the storage.

Accordingly, the computer is operable to extract the lines and the characters separately from the input image and when the extracted lines are of the specific format, correlate the extracted characters with the specific format of the extracted lines and store the same in the storage. This prevents the image of the lines from being stored redundantly. When the extracted lines are not of the specific format, they are stored in the storage by the computer. This allows the stored lines of another format to be used as a reference for the determination when a new input image is received.

According to the present invention, when it is determined that the input image is equal to the stored image added with written data, a region containing the written data is extracted from the input image and the image data thereof is stored in the storing unit. This allows the image data to be stored separately while a specific format is provided for common use, such as a format including mainly characters or a format including characters and lines.

According to the present invention, when two or more of the regions containing the written data are extracted, the image data thereof are stored in the region-by-region basis in the storing unit. This allows a composite image of the extracted region and the specific format to be edited for, for example, inhibiting the output of a desired portion.

According to the present invention, since the image to be stored is encoded, the memory size of the storage can be minimized.

According to the present invention, since the images encoded and stored are read and decoded before being combined together, the data can be used for producing a print in the specific format such as a ledger sheet.

According to the present invention, the characters and the lines are extracted separately from the input image and when it is decided that the extracted lines are of a specific format, the extracted characters are correlated with the specific format of the lines and stored in the storing unit. This prevents the image of the lines from being stored redundantly, thus minimizing the memory size of the storing unit required for filing a text in the specific format such as a ledger sheet. Also, when it is decided that the extracted lines are not of the specific format, the extracted line are stored as a new format in the storing unit. This allows the extracted lines stored to be used as a reference for the determination on another input image to be stored.

According to the present invention, even when it is decided that the extracted lines are not of the specific format, the extracted lines and the extracted characters can be stored in association with each other.

According to the present invention, since the extracted lines and the extracted characters are encoded, the memory size of the storing unit required for the filing can be minimized. In particular, as the encoding ratio is increased by encoding the extracted lines and the extracted characters separately, the memory size required for the filing can significantly be reduced.

According to the present invention, since the lines and the characters encoded and stored are decoded and combined, the data can be used for producing a print such as a ledger sheet.

According to the present invention, the image reading apparatus can be implemented in the form of a scanner for storing desired images.

According to the present invention, since the lines and the characters are stored in association with each other before read out and combined together to print the combination thereof on a sheet, the data can be used for, for example, producing a ledger sheet.

According to the present invention, since the recording medium carries a computer program for driving a computer to perform the above described processes, a desired group of lines (rules) can be read and written using any computer as long as it can execute the computer program.

The above and further objects and features of the present invention will more fully be apparent from the following detailed description with accompanying drawings.

### BRIEF DESCRIPTION OF THE SEVERAL VIEWS OF THE DRAWINGS

FIG. 1 is a block diagram for explaining the internal arrangement of an image processing system equipped with an image processing apparatus according to one embodiment of the present invention;

FIG. 2 is a block diagram showing the internal arrangement of a document matching process section;

FIG. 3 is a block diagram showing the internal arrangement of a feature point calculating section;

FIG. 4 is a schematic diagram showing a mixing filter provided in a filtering processor;

FIGS. 5A and 5B are schematic views showing the extraction of feature points;

FIG. 6 is an explanatory view showing a current feature point and its surrounding feature points;

FIGS. 7A to 7C are explanatory views showing the calculation of an invariant about a current feature point P1;

FIGS. 8A to 8C are explanatory views showing the calculation of an invariant about a current feature point P4;

FIGS. 9A to 9D are other explanatory views showing the calculation of an invariant about a current feature point P1;

FIGS. 10A to 10D are other explanatory views showing the calculation of an invariant about a current feature point P4;

FIGS. 11A and 11B are schematic views of an example of a hash value table showing the relationship between hash values and stored formats;

FIG. 12 is a schematic view showing an example of a counting table for counting the result of voting;

FIG. 13 is a schematic view showing an example of a table which carries indices of the stored format and coordinates of feature points;

FIG. 14 is a graph showing an example of the voting result;

FIG. 15 is a flowchart for explaining a procedure conducted in the document matching process section;

FIG. 16 is a flowchart for explaining a procedure of extracting a written region;

FIG. 17 is an explanatory view showing correlation between the input image with the stored format;

FIGS. 18A and 18B are schematic views showing an example of the stored format;

FIG. 19 is a schematic view showing a table which defines regions to be extracted for each stored format;

FIG. 20 is a block diagram for explaining the internal arrangement of an image processing system equipped with an image processing apparatus according to one embodiment of the present invention;

FIG. 21 is a block diagram showing the internal arrangement of a filing process section;

FIGS. 22A to 22C are schematic views showing an exemplary action of extracting an image of ruled lines and an image of characters;

FIGS. 23A to 23C are schematic views showing another exemplary action of extracting an image of ruled lines and an image of characters;

FIGS. 24A to 24C are schematic views showing a further exemplary action of extracting an image of ruled lines and an image of characters;

FIG. 25 is a schematic view illustrating a list of stored images of ruled lines;

FIG. 26 is a schematic view illustrating a list of stored images of characters;

FIG. 27 is a flowchart showing a procedure for storing the image of ruled lines and the image of characters; and

FIG. 28 is a block diagram for explaining the internal arrangement of an image processing apparatus where a computer program for conducting the above described procedure is installed.

### DETAILED DESCRIPTION

Preferred embodiments of the present invention will be described in detail referring to the accompanying drawings.

### First Embodiment

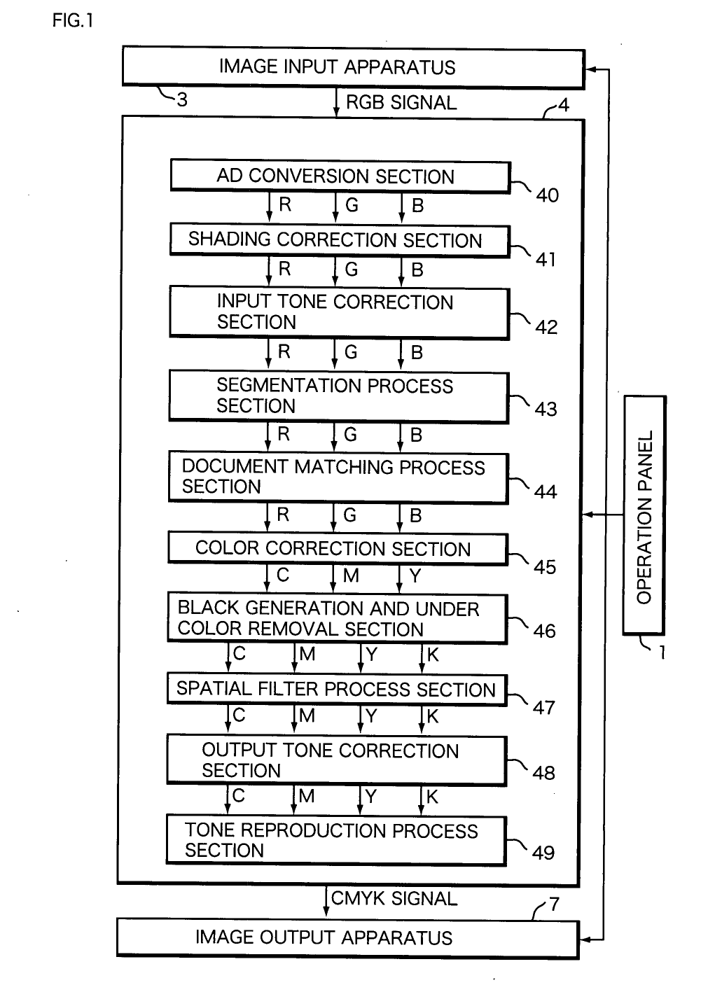

FIG. 1 is a block diagram for explaining the internal arrangement of an image processing system equipped with an image processing apparatus, according to one embodiment of the present invention. The image processing system according to this embodiment includes an operation panel 1, an image input apparatus 3, an image processing apparatus 4, and an image output apparatus 7.

The operation panel 1 is an interface for receiving instructions from a user and includes an operating unit provided with various switches, buttons, etc. and a display unit for displaying data, images, etc. to be informed to a user.

The image input apparatus 3 is a unit for optically reading an image of a document and includes a light source for emitting light towards the document to be read and an image sensor such as a charge coupled device (CCD). The image input apparatus 3 focuses a reflected image from the document placed at a predetermined reading position on the image sensor and outputs an analog electric signal of RGB colors (R: red, G: green, and B: blue). The analog electric signal outputted from the image input apparatus 3 is transferred to the image processing apparatus 4.

The image processing apparatus 4 converts the analog electric signal received from the image input apparatus 3 into a digital electric signal which is then subjected to appropriate image processing and the resultant image data is dispatched to the image output apparatus 7. The internal arrangement and operation of the image processing apparatus 4 will be described later in more detail.

The image output apparatus 7 is a unit for creating an image on a sheet such as paper and an OHP film based on the image signal received from the image processing apparatus 4. For forming an image to be desired by the user on the sheet through an electrophotographic method, the image output apparatus 7 includes a charger for charging a photoconductive drum to a predetermined potential, a laser writer for emitting a laser beam in response to the image data received from the outside to produce an electrostatic latent image on the photoconductive drum, a developer for applying toner to the electrostatic latent image produced on the photoconductive drum to visualize the image, and a transfer device (not shown) for transferring the toner image produced on the photoconductive drum onto the sheet. The method of forming images is not limited to the electrophotographic method using a laser writer but may be selected from any other applicable image forming methods including ink-jet printing, thermal printing, and sublimate printing.

The internal arrangement of the image processing apparatus 4 will be described next. An AD conversion section 40 is provided for converting an analog signal of RGB colors received from the image input apparatus 3 into a digital signal. A shading correction section 41 is provided for subjecting the digital signal of RGB colors received from the AD conversion section 40 to a process of eliminating various distortions developed in the illuminating system, the image focusing system, and the image sensing system of the image input apparatus 3. After subjected to the process of shading compensation, the RGB signal is dispatched to an input tone correction section 42.

The input tone correction section 42 is provided for conducting a process such as removing page background density and adjusting image quality such as contrast. A segmentation process section 43 is provided for separating and allocating pixels of the input image based on the RGB signal into a character region, a halftone region, and a photograph region. Based on the result of the separation, the segmentation process section 43 produces and dispatches a segmentation class signal indicative of the region assigned with pixels to a black generation and under color removal section 46, a spatial filter process section 47, and a tone reproduction process section 49 connected downstream while transferring the received RGB signal directly to a document matching process section 44 connected downstream.

The document matching process section 44 examines whether or not the image (input image) of the input signal is similar to a stored image (referred to as a stored format hereinafter) and if so, examines whether or not the input image is an image formed by writing in the stored format. When the input image is the image formed by writing in the stored format, the region corresponding to the writing-in is extracted and stored in association with the stored format.

A color correction section 45 is provided for removing color impurity through checking the spectral characteristic of C, M, and Y components including useless absorption components in order to reproduce the colors with high fidelity. The color-corrected RGB signal is then transferred to the black generation and under color removal section 46. The black generation and under color removal section 46 is provided for producing a K (black) signal from the color-corrected C, M, and Y components of the primary color signal and subtracting the K signal from the original C, M, and Y signals to generate a new set of C, M, and Y signals. More particularly, this process generates four, i.e., C, M, Y, and K signals from the three original color signal.

The generation of black signal may be conducted by a skeleton black method. Assuming that the input/output characteristic of a skeleton curve is y=f(x), the input data are C, M, and Y, the output data are C′, M′, Y′, and K′, and the UCR (under color removal) rate is a (where 0<α<1), the process of black generation and under color removal is expressed by the next expressions.

K′=F{min(C,M,Y)}

C′=C−αK′

M′=M−αK′

Y′=Y−αK′

The spatial filter process section 47 is provided for subjecting the C, M, Y, and K signals of image data received from the black generation and under color removal section 46 to an spatial filtering process with the use of a digital filter based on the segmentation class signal thus to correct the spatial frequency characteristic for eliminating any blur or granular deterioration in the output image.

For example, when the image is separated into a character region by the segmentation process section 43, for improving the reproducibility of achromatic text or chromatic text, the data thereof is subjected to the spatial filtering process of the spatial filter process section 47 for sharpening or increasing the degree of enhancement for high frequencies. This is followed by the tone reproduction process section 49 performing binarization or multivaluing process with a high-resolution screen suitable for reproduction of the high frequencies. When the image is separated into a halftone region by the segmentation process section 43, the data thereof is subjected to a low-pass filtering process of the spatial filter process section 47 for removing input halftone components. This is followed by an output tone correction process of the output tone correction section 48 for converting signals including density signals to a halftone area rate signal which represents a characteristic of a color image display apparatus and then a gradation reproducing process of the tone reproduction process section 49 for finally separating the image into pixels to reproduce respective gray level thereof. When the image is separated into a photograph region by the segmentation process section 43, the data thereof is subjected to the binarization or multivaluing process with a screen specified for reproduction of the gradation.

The image data on which the above described processes have been performed is temporarily stored in a memory unit (not shown), read out from the same at a desired timing and transferred to the image output apparatus 7.

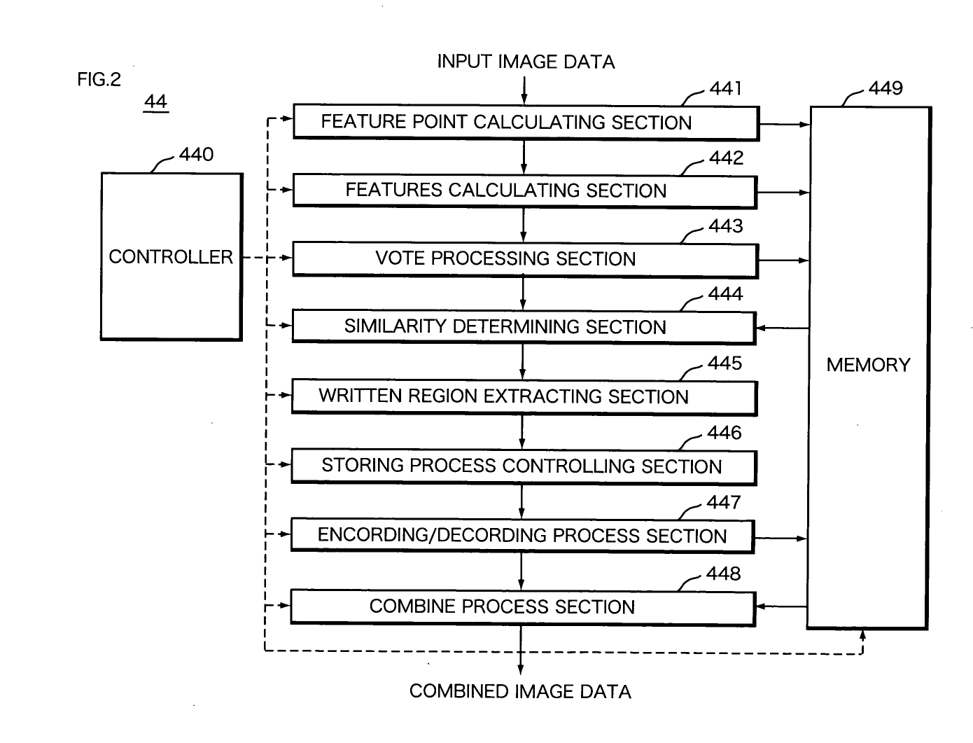

FIG. 2 is a block diagram showing an internal arrangement of the document matching process section 44. The document matching process section 44 includes a controller 440, a feature point calculating section 441, a features calculating section 442, a vote processing section 443, a similarity determining section 444, a written region extracting section 445, a storing process controlling section 446, a encoding/decoding process section 447, and a combine process section 448.

The controller 440 may be a CPU for controlling the action of each units of hardware described above. The feature point calculating section 441 is provided for extracting a connected region from a character string or ruled lines in the input image and calculating the centroid in the connected region as a feature point. The features calculating section 442 is provided for calculating features which remain unchanged regardless of rotation, enlargement, and reduction based on the feature point calculated by the feature point calculating section 441. The vote processing section 443 is provided for voting a stored format based on the features calculated by the features calculating section 442. The similarity determining section 444 is provided for determining from the voting result whether or not the input image is similar to the stored format.

The written region extracting section 445 is provided for, when it is determined that the input image is similar to the stored format, extracting a character string and a picture written in the stored format from the input image. The stored process controlling section 446 is provided for, when it is determined that the input image is similar to the stored format, assigning an ID with the stored format and supplying the encoding/decoding process section 447 with each extracted region of the image data. When the input data is not similar to the stored format, a message is created and displayed on the operation panel 1 for prompting storing the input image as a stored format.

The encoding/decoding process section 447 encodes the image data extracted by the written region extracting section 445, using a method such as Modified Huffman (MH), Modified Read (MR), Modified Modified Read (MMR), or Joint Photographic Experts Group (JPEG). The encoding method of MH includes encoding the run length of white run and black run in each line into a Huffman format and adding to the end of one-line encoded data a line sync signal EOL. The encoding method of MR is a modification of MH for encoding the data of interest correlated with the data in the previous line to increase the data encoding ratio. More specifically, the data in the first line is encoded by the MH method and the data in the second line to the k-th line is encoded using correlation with the previous line. The data of the (k+1)th line is then encoded by the MH method. These steps are repeated. The encoding method of MMR is a modification of MR where k=∞ for encoding constantly using the correlation with the previous line. The method of JPEG includes diving the image into blocks of a desired size and converting each block into a spatial frequency region level by discrete cosine transform. The converted data is then quantized for reduction of data size and subjected to an entropy coding using Huffman code. The resultant encoded data is stored in a memory 449. When the encoded data is read out from the memory 449, it is subjected to decoding by the encoding/decoding process section 447. The combine process section 448 combines the decoded image data with the stored format.

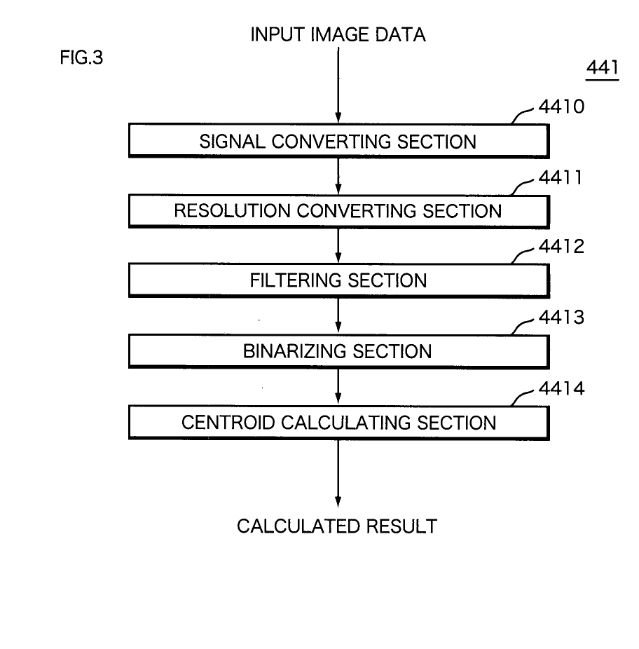

The processing performed by the document matching process section 44 will be described in more detail. FIG. 3 is a block diagram showing an configuration of the feature point calculating section 441. The feature point calculating section 441 includes an achromatizing section 4410, a resolution converting section 4411, a filtering section 4412, a binarizing section 4413, and a centroid calculating section 4414.

The achromatizing section 4410 is provided for, when the input data is a color image, achromatizing and converting the input data into a brightness signal or a luminance signal. For example, the luminance signal can be obtained from the next expression.

Yj=0.30Rj+0.59Gj+0.11Bj

Where Yj is the luminance of each pixel and Rj, Gj, and Bj are three color component values of each pixel. Alternatively, the RGB signal may be converted into CIE1976L*a*b* signals (CIE: Commission International de l'Eclairage, L*: Lightness, a*, b*: chroma).

The resolution converting section 4411 is provided for, when the input data has optically been multiplied at the image input apparatus 3, multiplying again to have a desired resolution. The resolution converting section 4411 also conducts a resolution converting process to reduce the resolution to be lower than that when the image is read at the same magnification by the image input apparatus 3, for easing the amount of processing downstream. For example, the image data read at 600 dpi (dot per inch) is converted to the image data at 300 dpi.

The filtering section 4412 is provided for absorbing a difference in the spatial frequency characteristic among the different models of the image input apparatus. The image signal produced by a CCD may contain a fault such as blur which caused by optical components including lenses and mirrors, aperture at the photosensitive surface of the CCD, transfer efficiency, residual images, scanning error or integration effects during the physical scanning, and the like. The filtering section 4412 subjects the input data to a proper filtering process (the enhancing process) to correct the blur caused by degradation of MTF. Also, it can suppress unwanted high frequency components which interfere with the processing downstream. Namely, a filter is used for performing the enhancing and smoothing processes.

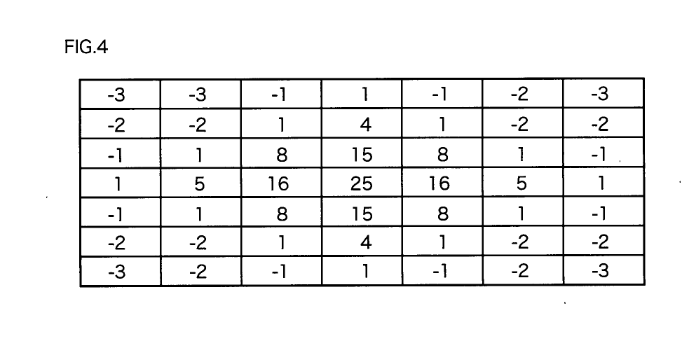

FIG. 4 is a schematic view showing an example of the filter used in the filtering section 4412. The filter may have a size of 7×7. The input data is scanned and its pixels are all subjected to the filtering of the filter. The filter is not limited to the size of 7×7 but may be have sizes of 3×3 or 5×5. The filter coefficients shown are illustrative and not limitative, and may be determined depending on the characteristic of the image input apparatus 3 to be used.

The binarizing section 4413 is provided for producing from the achromatic image data binary image data suitable for calculation of the centroid.

The centroid calculating section 4414 is provided for calculating and outputting, as a feature point, a centroid in connected components in the binarized data to the features calculating section 442. The calculation of the centroid may be carried out by a known method. More specifically, the method includes labeling each pixel in the binarized data of the binary image, specifying the connected region defined by the pixels assigned with the same label, and calculating the centroid in the specified connected region as a feature point.

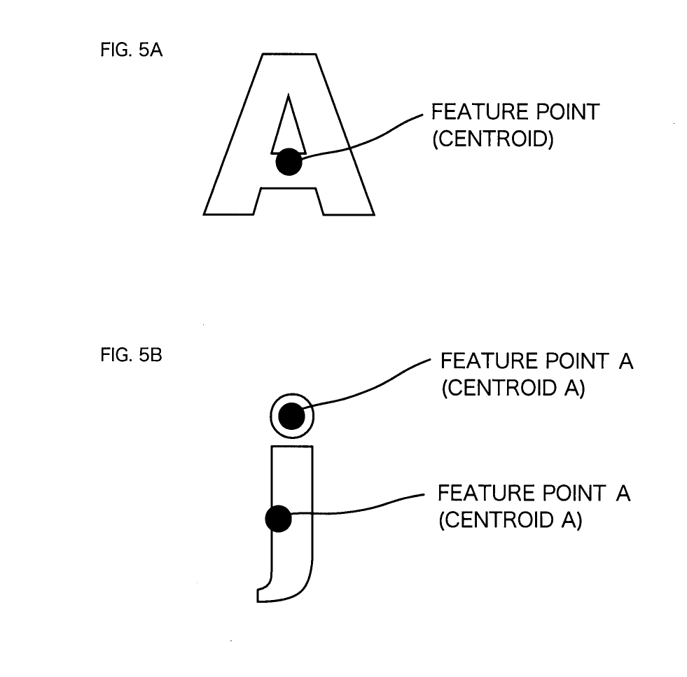

FIGS. 5A and 5B are schematic views showing the extraction of the feature point. FIG. 5A illustrates a character “A” specified as the connected region through the above described method and a point denoted by a black dot in the figure is calculated as the feature point (the centroid). Similarly, FIG. 5B illustrates two separated connected regions of a character “j”. Since the feature point (centroid) is extracted from each of the connected regions, two feature points are extracted from the single character as denoted by A and B.

The calculation of the features will be described. The features calculating section 442 calculates the features of an image from a plurality of feature points determined by the feature point calculating section 441. More particularly, one of the feature points is selected as a current feature point and four of the feature points which are close to the current feature point are then selected as surrounding feature points.

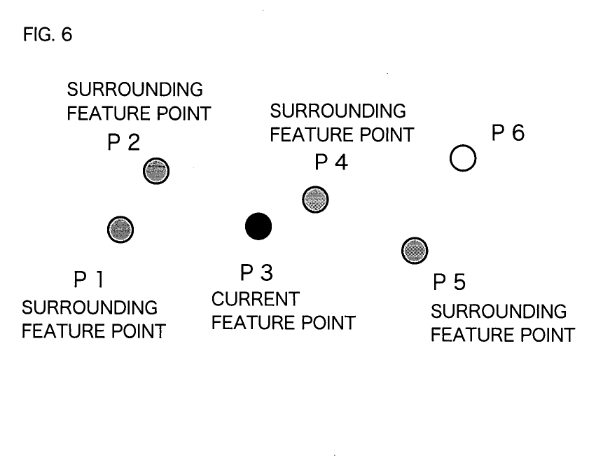

FIG. 6 is an explanatory view showing the current feature point and its surrounding feature points. In FIG. 6, six of the feature points P1 to P6 are shown as determined by the feature point calculating section 441. While the feature point P3 is selected as the current feature point by the features calculating section 442, the other feature points P1, P2, P4, and P5 are selected as the surrounding feature points. The features calculating section 442 calculates from the current feature point P3 and its surrounding feature points P1, P2, P4, and P5 a value remaining unchanged during inclination, movement, or rotation of the input image and determines from the invariant features indicative of the feature of the input image.

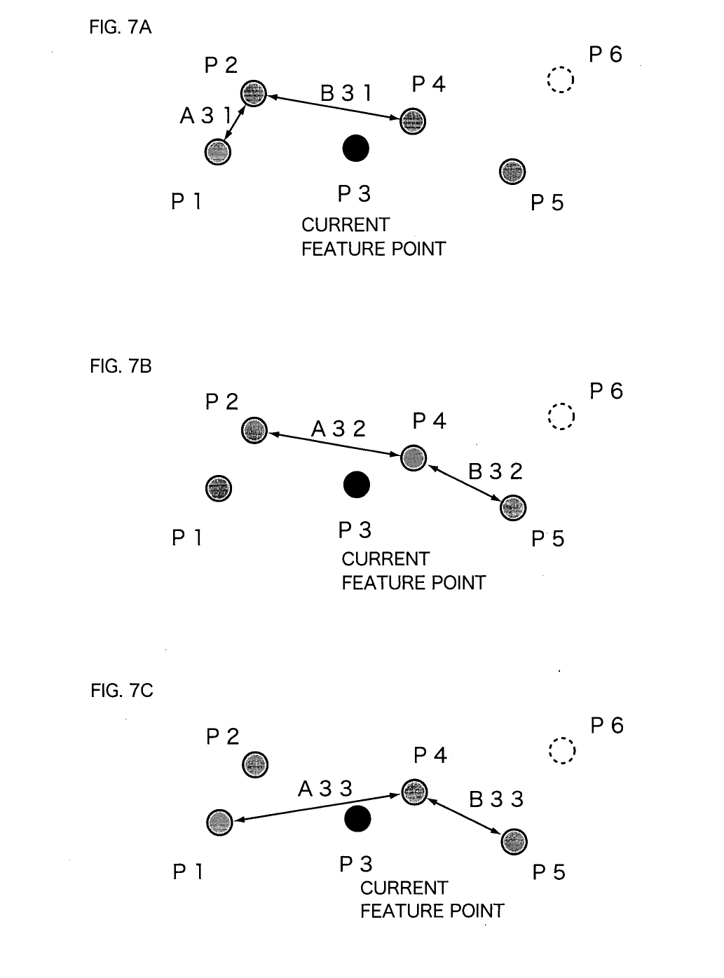

FIGS. 7A to 7C are explanatory views illustrating steps of calculating the invariants when the current feature point is at P1. The invariant H3j is defined by H3j=A3j/B3j using the distances from the current feature point P3 to the surrounding feature points P1, P2, P4, and P5. Assuming j=1, 2, and 3, the A3j and B3j represent the distances between the feature points which are calculated from coordinate values. More specifically, the three invariants are determined, H31 from A31/B31 (See FIG. 7A), H32 from A32/B32 (See FIG. 7B), and H33 from A33/B33 (See FIG. 7C). Since the invariant H3j remains unchanged when the document is rotated, moved, or inclined during the scanning, the determination of the similarity downstream can thus be conducted with a high degree of accuracy.

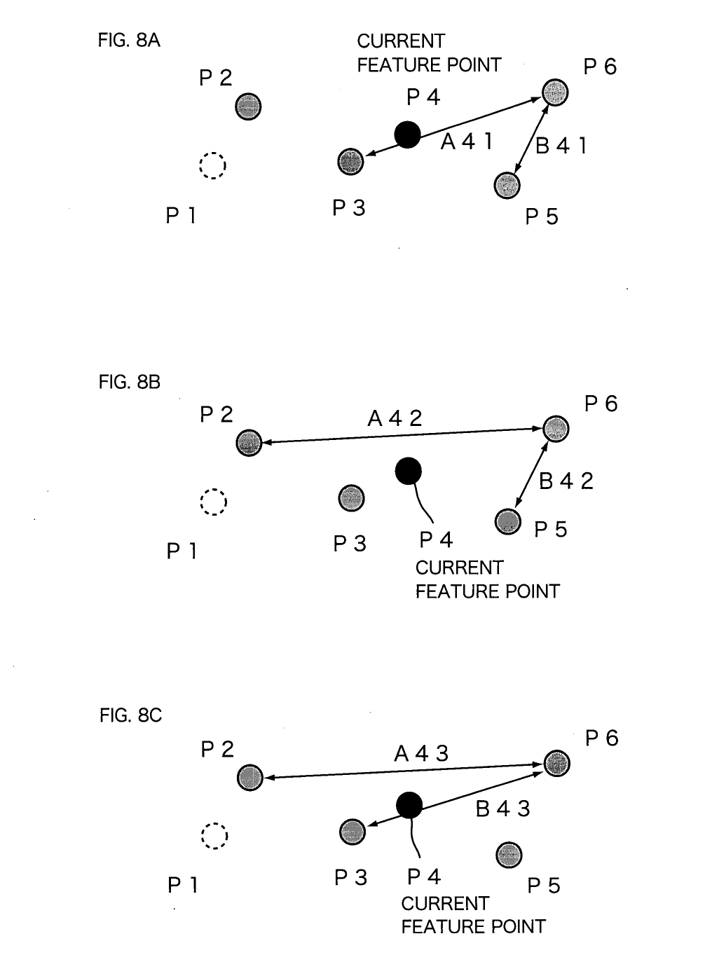

FIGS. 8A to 8C are explanatory views illustrating steps of calculating the invariants when the current feature point is at P4. The surrounding feature points P2, P3, P5, and P6 are selected by the features calculating section 442. Similarly, the invariant H4j (j=1, 2, 3) is determined from H4j=A4j/B4j. Accordingly, the three invariants are determined, H41 from A41/B41 (See FIG. 8A), H42 from A42/B42 (See FIG. 8B), and H43 from A43/B43 (See FIG. 8C).

The similar processing is performed when any of the feature points P1, P2, P5, and P6 is selected as the current feature point. As changing the current feature point one by one, the features calculating section 442 calculates the invariant Hij (i=1, 2, . . . , 6 and j=1, 2, 3) when the current feature points are at P1, P2, . . . P6.

The features calculating section 442 calculates features (a hash value Hi) from the invariant calculated based on the current feature point. When the current feature point is at Pi, the hash value Hi is expressed by Hi=(Hi1×10²+Hi2×10¹+Hi3×100)/E, where i is positive integer and expresses the number of the feature points and also E is a constant determined depending on the margin. For example, the margin ranges from 0 to 9 when E=10. The hash value can thus fall in the range.

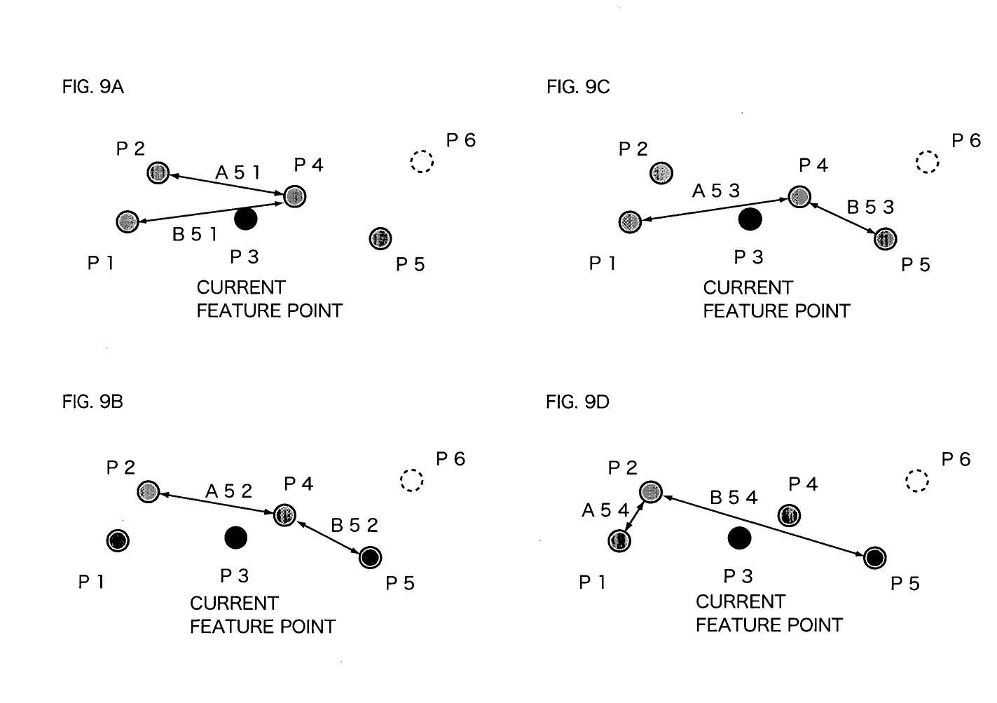

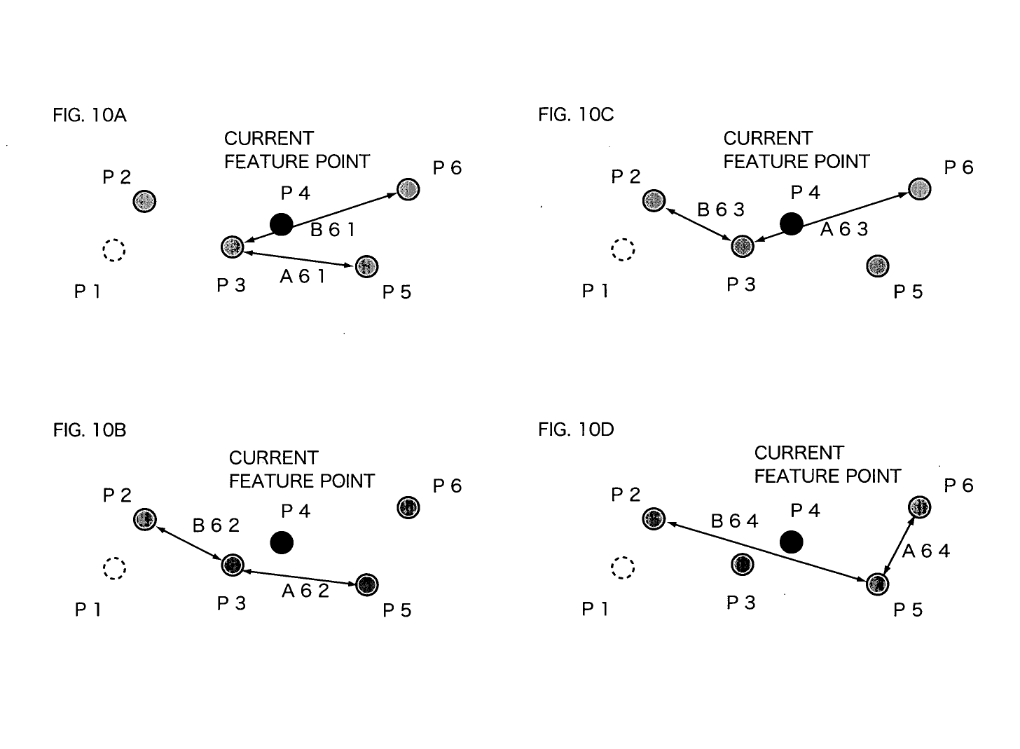

Another calculating method for an invariant about the current feature point may be comprising the steps of selecting four combinations based on the four surrounding feature points P1, P2, P3, P4 around the current feature point P3 as shown in FIG. 9A to 9D, and determining the invariant H5j (j=1, 2, 3, 4) as expressed by H5j=A5j/B5j. Similary, an invariant about the current feature point P4 may be calculated by H6j (j=1, 2, 3, 4)=A6j/B6j, after the selection of four combinations based on the four surrounding feature points P2, P3, P5, P6 around the current feature point P4 as shown in FIG. 10A to 10D. A hash value Hi is expressed by Hi=(Hi1×10²+Hi2×10¹+Hi3×100)/E.

The features are not limited to the hash value and may be calculated using any other hash function. The peripheral points are selected, but not limited to, four in the embodiment, and they may be six. In the latter case, five out of the six feature points are extracted in six different combinations. When three are extracted from the five points to determine the invariant from which the hash value can be calculated.

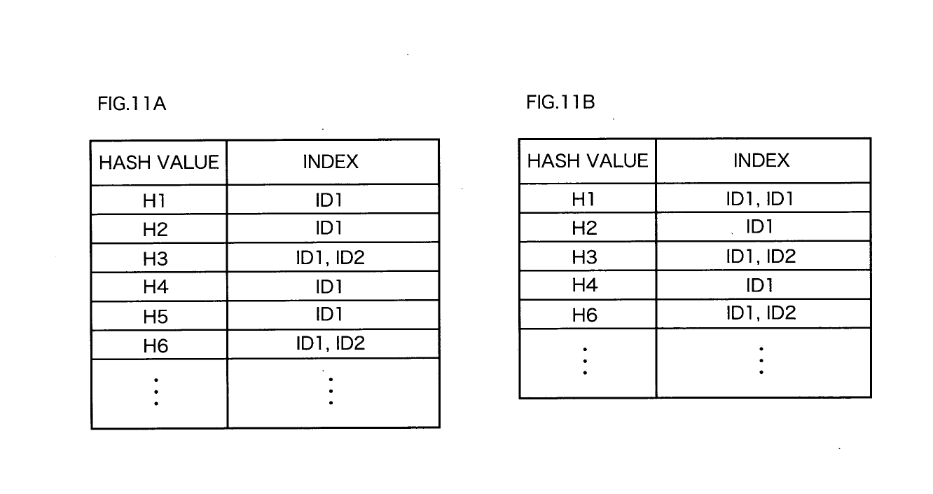

The image data stored as the stored format in the memory 449 is thus correlated with the hash value calculated in the foregoing manner. FIGS. 11A and 11B illustrate exemplary tables showing the relationship between the hash value and the stored format. The hash tables are constituted by combinations of the hash value and the index representing the stored format. More specifically, as shown in FIG. 11A, the point index indicative of the location in the image and the invariant are stored corresponding to the index indicative of the stored format. For examining the similarity in images, a set of images and texts to be collated are stored in the hash table. As shown in FIG. 11B, when two hash value are identical (H1=H5), their entries can be expressed by one entry in the table denoted by 12b.

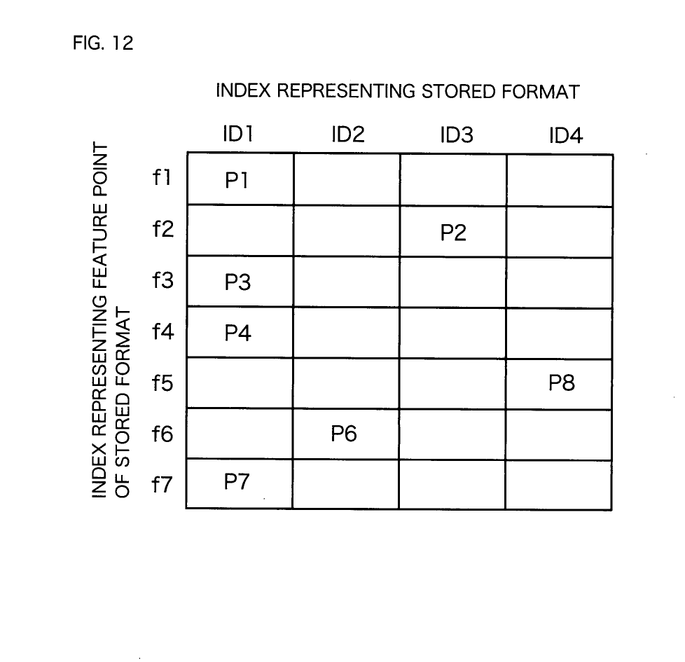

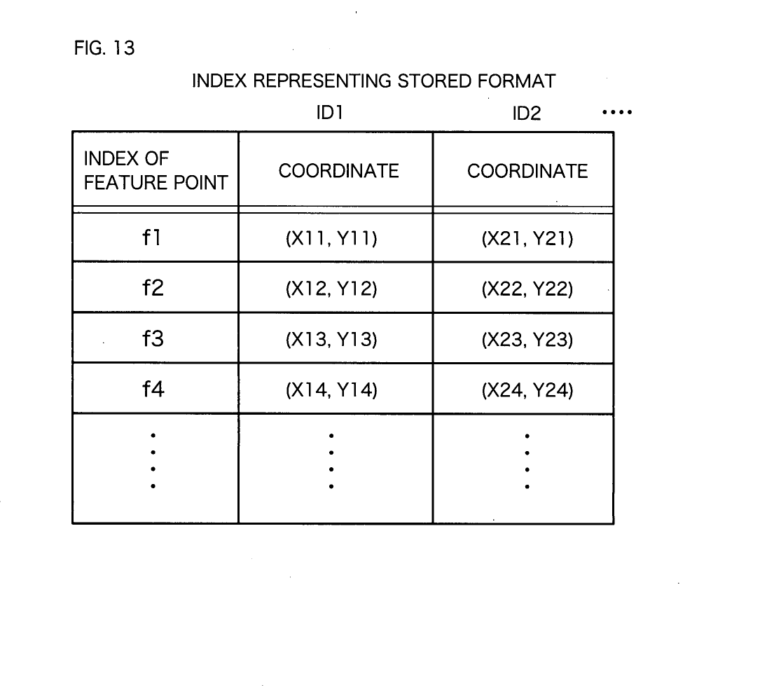

The vote processing section 443 is provided for retrieving the hash table corresponding to the hash value (the features) calculated by the features calculating section 442 and voting for the document of the index stored in the table. The voting result is stored, specifying which of the feature points in the stored format is voted by the feature point of interest in the input image. FIG. 12 illustrates an example of counting table for counting the voting result. In the table shown in FIG. 12, it is determined that the features (a hash value) based on the feature point P1 in the input image corresponds to the features at the feature point f1 in the stored format 1D1. With respect to the other feature points P2 to P7 in the image data, determination is similarly made. It should be noted that the index identifying each feature point in the stored format and the coordinates of the feature point have been stored in advance. FIG. 13 illustrates an exemplary table where the index of the stored format and the coordinates of the feature point are stored.

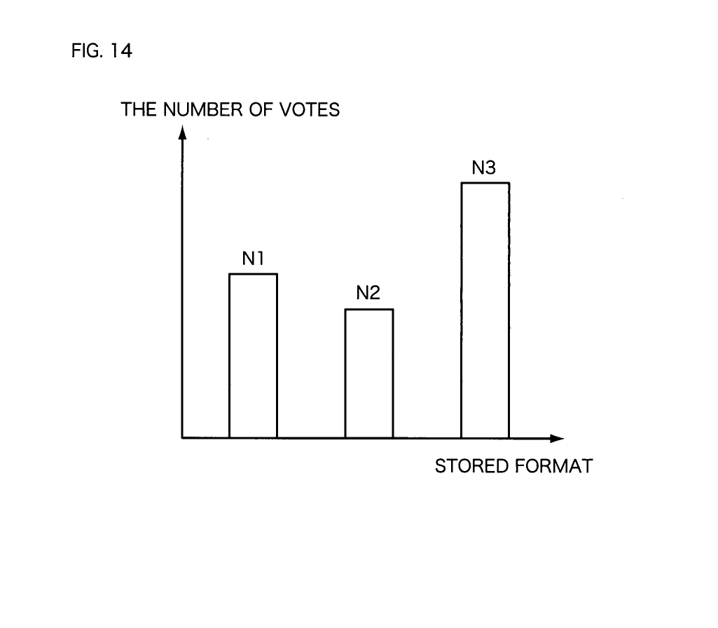

FIG. 14 is a graph showing one of the voting result. The types of the stored format are shown along the horizontal axis while the number of votes is expressed along the vertical axis. FIG. 14 shows that the voting is carried out for three types of the stored format (N1 to N3). A cumulative sum of the voting result is then transferred to the similarity determining section 444.

The similarity determining section 444 is provided for determining the similarity of the input image based on the voting result received from the vote processing section 443 and notifying the controller 440 of a result of the judgment. The similarity determining section 444 compares the number of votes received from the vote processing section 443 with a predetermined threshold and, when the number of votes is equal to or larger than the threshold, determines that the input image is similar to the stored format. When the number of votes is smaller than the threshold, the similarity determining section 444 determines that no similar document is present and notifies the controller 440 of a result of the determination.

The foregoing method is illustrative and may be conducted through any other proper processes such as dividing the number of votes by the maximum number of votes (the number of feature points to be calculated) for each document and normalizing the result thereof, and carrying out the comparison and the determination.

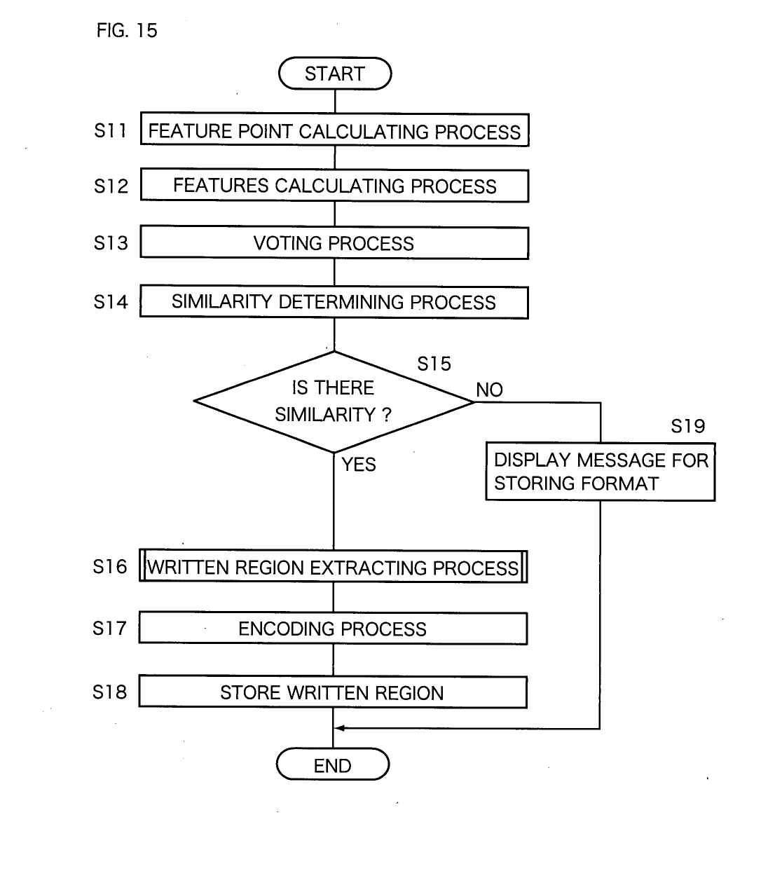

The sequence of processing will be described for reading the image of a document of a predetermined format such as a ledger sheet with the image input apparatus 3 and subjecting the read image to the collating processing of the document matching process section 44. FIG. 15 is a flowchart showing the sequence of steps to be conducted by the document matching process section 44. The processing of the document matching process section 44 starts with calculating the feature point in the input image (Step S11). As described above, the input image is binarized, labeled at each pixel according to the binarized data for specifying the connected region where the pixels assigned with the same label are connected, and calculating the centroid in the connected region as the feature point.

The document matching process section 44 calculates the features in the input image from the feature point (Step S12). More specifically, the features calculating section 422 in the document matching process section 44 selects one of the feature points as the current feature point, calculates based on the current feature point and its surrounding feature points the invariant which remains unchanged during the movement or rotation of the input image, and determines the features in the input image from the invariant.

The document matching process section 44 retrieves the hash table as shown in FIG. 12 based on the hash value which represents the features determined by the features calculating section 442 and votes for the stored format stored with index (Step S13).

The document matching process section 44 determines the similarity between the input image and the stored format from the result of voting in Step S13 (Step S14) and examines whether or not the input image is similar to the stored format (Step S15). More specifically, the number of votes for the stored format listed in the hash table is compared with the predetermined threshold. When the number of votes is equal to or larger than the threshold, it is determined that the input image is similar to the stored format. When the number of votes is smaller than the threshold, it is determined that the input image is dissimilar to the stored format.

When determining that the input image is similar to the stored format (yes in S15), the document matching process section 44 extracts the region where the stored format is written in (Step S16). The process of extracting the written region will be described later in more detail.

The written region determined in the process of extracting the written region is then subjected to a encoding process (Step S17) and, accompanied by a form ID which indicates the correlation with the stored format, the encoded region is stored in the memory 449 (Step S18). When determining that the input image is not similar to the stored format (no in S15), the document matching process section 44 displays on the operation panel 1 a message for storing a format (Step S19).

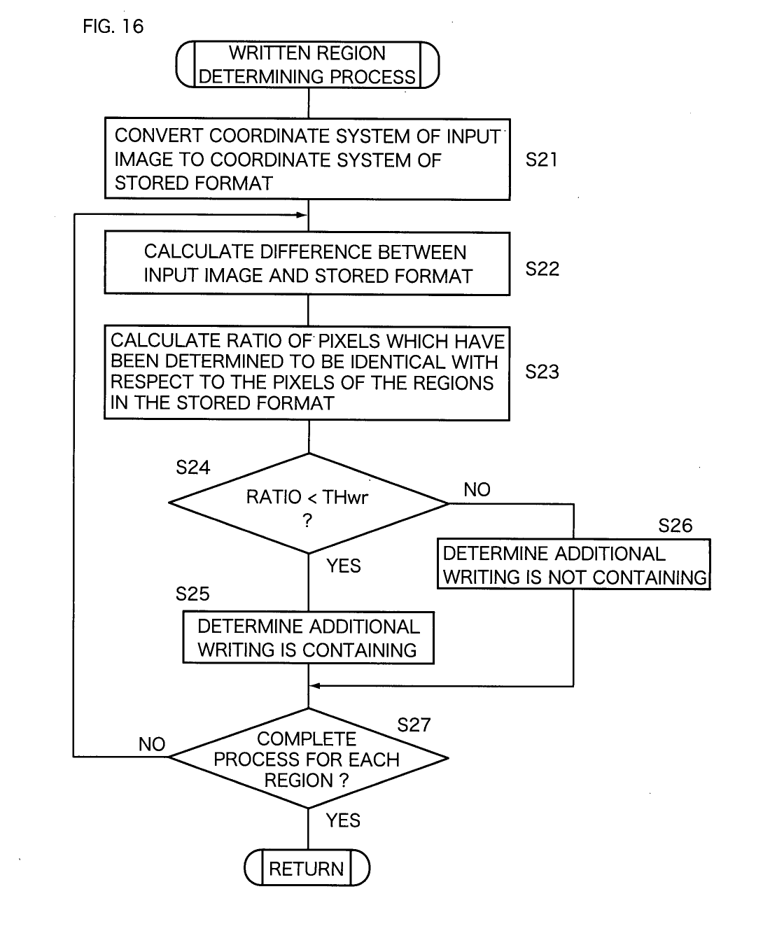

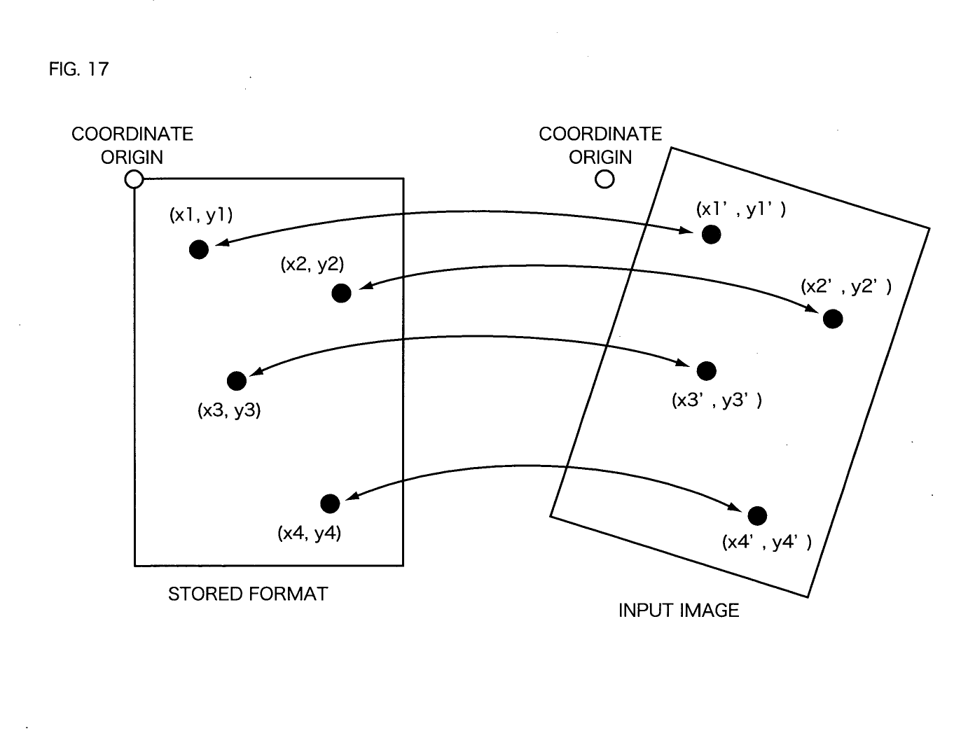

FIG. 16 is a flowchart showing the procedure for extracting the written region. The written region extracting section 445 converts the coordinate system of the input image to the coordinate system of the stored format (Step S21). This procedure starts with correlating the coordinates of the feature point in the input image calculated in Step S11 with the coordinates of the feature point in the stored format which is determined to be similar to the input image. FIG. 17 is an explanatory view showing the correlation of the input image with the stored format. The coordinates of the four feature points in the stored format are denoted by (x1, y1), (x2, y2), (x3, y3), and (x4, y4) and respectively correlated with the coordinates (x1′, y1′), (x2′, y2′), (x3′, y3′), and (x4′, y4′) of the four feature points in the input image which have been calculated.

Assuming that Pin is a matrix created using the coordinates of the feature points in the stored format, Pout is a matrix created using the coordinates of the feature points in the input image, and A is a transform matrix between the two matrixes Pin and Pout, the relationship of the coordinates between the stored format and the input image is expressed by the next expression.

$$Pout = Pin \times A$$

$$Where , \\ Pin = ( \begin{matrix}x 1 & y 1 & 1 \\ x 2 & y 2 & 1 \\ x 3 & y 3 & 1 \\ x 4 & y 4 & 1\end{matrix} ) , Pout = ( \begin{matrix}x {1}^{′} & y {1}^{′} & 1 \\ x {2}^{′} & y {2}^{′} & 1 \\ x {3}^{′} & y {3}^{′} & 1 \\ x {4}^{′} & y {4}^{′} & 1\end{matrix} ) , A = ( \begin{matrix}a & b & c \\ d & e & f \\ g & h & i\end{matrix} )$$

As the matrix Pin is not a square matrix, it is multiplied at both sides by the transposed matrix Pin^{T} of Pin and then by an inverse matrix of Pin^{T}Pin to obtain a transform matrix A.

A=(Pin^{T}Pin)⁻Pin^{TPout}

Then, the relationship between the coordinates (x′, y′) in the input image and the coordinates (x, y) in the stored format is expressed by the next expression.

(x′,y′,1)=(x,y,1)×A

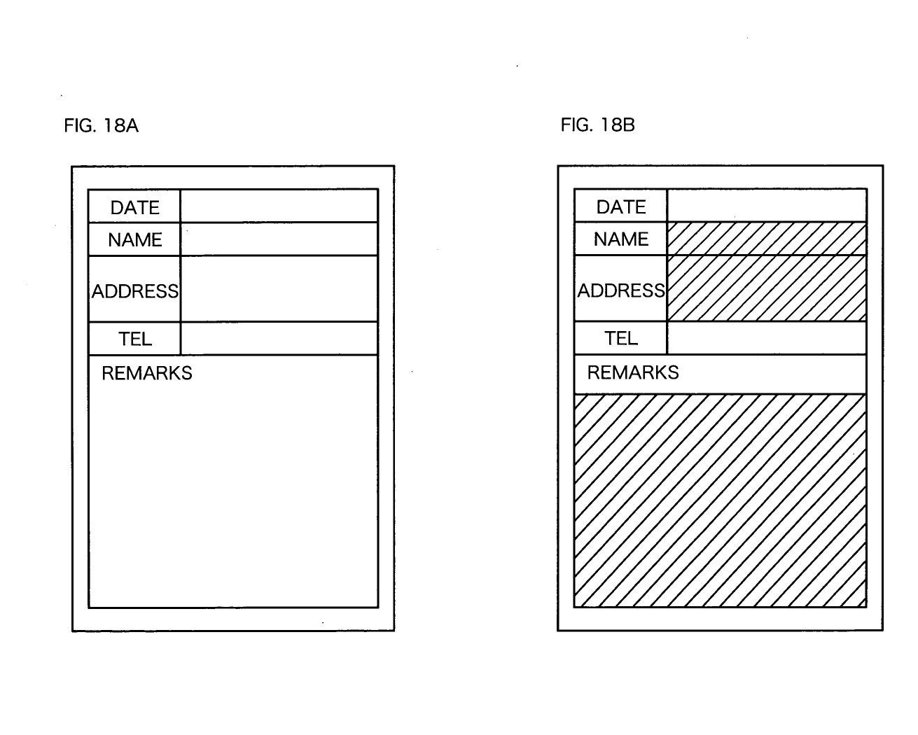

The transformation of the coordinates with the transform matrix A is used for determining a region to be extracted from the input image. The process of extracting the region from the image of, for example, a ledger sheet produced using the stored format will be described. FIGS. 18A and 18B schematically illustrate an example of the stored format. The stored format shown in FIG. 18A includes a date blank, a name blank, an address blank, a telephone number blank, and a remarks blank. A ledger sheet prepared using this stored format has character strings filled in the date blank, the name blank, the address blank, the telephone number blank, and the remarks blank. The characters written in the ledger sheet may be written by a human hand or electronically recorded by, e.g., a computer.

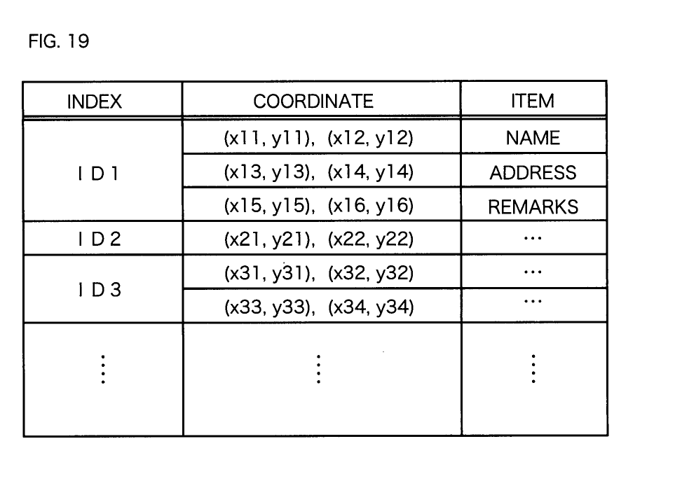

When the character strings are read and extracted as images from, e.g., the name blank, the address blank, and the remarks blank, the rectangular regions denoted by the hatching in FIG. 18B are scanned. It is hence necessary to store in advance the coordinates which specify each rectangular region for each stored format. For example, when the coordinates at the four corners of the name blank are denoted by (x11, y11), (x12, y11), (x11, y12), and (x12, y12), two sets of the coordinates (x11, y11) and (x12, y12) at the two diagonal corners of the rectangular region are stored. This is similarly performed for the address blank and the remarks blank. FIG. 19 is a schematic diagram of a table listing the regions to be extracted in each stored format. In the table, the diagonal coordinates specifying the region to be extracted and the corresponding item name are stored with the index assigned with the stored format.

When the coordinate system of the input image is converted into the coordinate system of the stored format using the inverse matrix of the transform matrix A, a difference between the input image and the stored format is calculated for each region to be extracted (Step S22). In the case where the image data is specified in 256 gray levels, the difference is taken such that, when the pixel values are varied within a small range of about 5 to 10, they are regarded as being identical, in consideration with the reproducibility of the pixel values at the time of reading the document.

Then, the ratio of pixels which have been determined to be identical is calculated with respect to the pixels of the regions in the stored format (Step S23) and the examination follows whether or not the ratio is smaller than the threshold THwr (0.99 for example) (Step 24). When the ratio is smaller than the threshold THwr (yes in Step S24), it is determined that something has been written in (Step S25).

When the radio is equal to or larger than the threshold THwr (no in Step S24), it is then determined that no writing-in has been made (Step S26).

It is then examined whether or not the above steps have been completed for each of the regions extracted (Step S27). When it is determined that they have not been completed (no in Step S27), the procedure returns back to Step S22. When it is determined that they have been completed (yes in Step S27), the procedure of this flowchart is terminated.

For reading the image data from the memory 449, the user selects the image data consisting of a character string to be handled. Alternatively, the image data of each character string is associated with a keyword in advance, and the data may be retrieved using the keyword and displayed in thumbnails or in a sequential manner for permitting the selection. Since the image data of the character string is also correlated with the stored format and the form ID, the coordinates of each region are examined to produce a composite image in combination with the corresponding stored format. At this time, an editing process in which a specific region (e.g., the name blank) is not outputted, for example, may be performed. The editing process may be carried out using the operation panel 1 which is provided with an editing mode and adapted to display the content of the process on the display for permitting the selection through touching the panel.

### Second Embodiment

Although in the first embodiment, the similarity between the input image and the stored image (stored format) is determined first and a desired region is extracted when it is determined that the two images are similar, the input image may first be subjected to the process of extracting the desired region before the similarity between the extracted region and that in the stored format is determined. In particular, the second embodiment includes reading of the image of a ledger sheet containing characters and ruled lines, extracting of the ruled lines from the image, and examining whether or not the extracted ruled lines are similar to those in a specific format stored in advance (referred to as a stored format hereinafter).

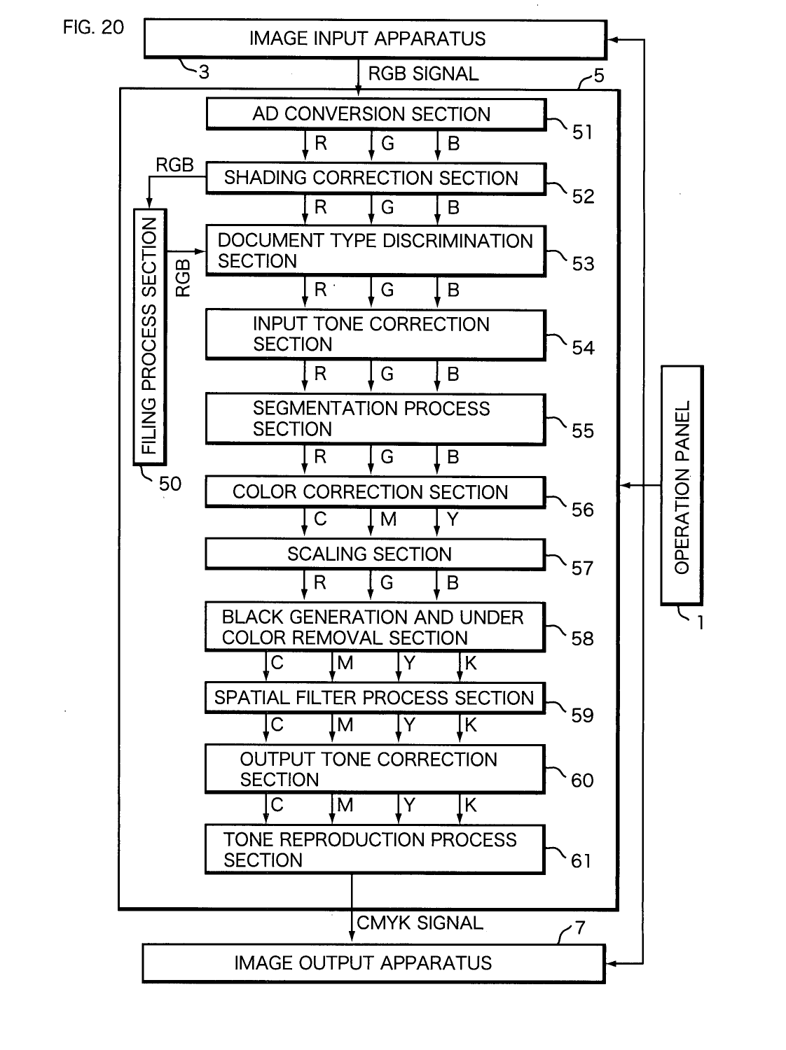

FIG. 20 is a block diagram of an internal arrangement of an image processing system equipped with an image processing apparatus, according to the present embodiment. The image processing system according to the second embodiment includes an operation panel 1, an image input apparatus 3, an image processing apparatus 5, and an image output apparatus 7.

The operation panel 1 is an interface for receiving instructions from a user and includes an operating unit provided with various switches and buttons and a display unit for displaying data, images, etc. to be informed to the user.

The image input apparatus 3 is a unit for optically reading an image of a document and includes a light source for emitting light towards the document to be read and an image sensor such as a charge coupled device (CCD). The image input apparatus 3 focuses a reflected image from the document placed at a predetermined reading position on the image sensor and outputs an analog electric signal of RGB colors (R: red, G: green, and B: blue). The analog electric signal outputted from the image input apparatus 3 is transferred to the image processing apparatus 5. In the present embodiment, a ledger sheet is set as the document.

The image processing apparatus 5 converts the analog electric signal received from the image input apparatus 3 into a digital electric signal, which is then subjected to appropriate image processing and the resultant image data is dispatched to the image output apparatus 7. The internal arrangement and operation of the image processing apparatus 5 will be described later in more detail.

The image output apparatus 7 is a unit for creating an image on a sheet such as paper or an OHP film based on the image signal received from the image processing apparatus 5. For creating a desired image on the sheet by an electrophotographic method, the image output apparatus 7 includes a charger for charging a photoconductive drum to a predetermined potential, a laser writer for emitting a laser beam in response to the image data received from the outside to produce an electrostatic latent image on the photoconductive drum, a developer for applying toner to the electrostatic latent image produced on the surface of the photoconductive drum to visualize the image, and a transfer device (not shown) for transferring the toner image formed on the surface of the photoconductive drum onto the sheet. The method of forming images is not limited to the electrophotographic method using a laser writer but may be selected from any other applicable image forming methods including ink-jet printing, thermal printing, and sublimate printing.

The internal arrangement of the image processing apparatus will be described next. An AD conversion section 51 is provided for converting an analog signal of RGB colors received from the image input apparatus 3 into a digital signal. A shading correction section 52 is provided for subjecting the digital signal of RGB colors received from the AD conversion section 51 to a process of eliminating various distortions developed in the illuminating system, the image focusing system, and the image sensing system of the image input apparatus 3. After subjected to the shading compensation process, the RGB signal is dispatched to a filing process section 50 and an document type discrimination section 53.

The filing process section 50 is provided for extracting a ruled line and a character from the input image and saving the extracted ruled line and character in association with each other. When the extracted ruled line is of a specific format which has been stored, it is not stored but the character image is stored together with an identifier for identifying the specific format (referred to as a form ID hereinafter). When the format of the extracted ruled line is not stored, the character image is stored in association with a form ID which is newly given for the format of the ruled line.

The document type discrimination section 53 is provided for converting the RGB signal (reflectance signal of RGB), which has been subjected to the processing by the shading correction section 52 for eliminating various distortions and adjusting the color balance, into a signal such as a density signal which can easily be handled by the image processing system commonly installed in a color image processing apparatus while discriminating the type of the document. The discrimination of the type of the document may be conducted by a known technique.

The input tone correction section 54 is provided for conducting image quality adjusting processes such as removing page background density and adjusting contrast. A segmentation process section 55 is provided for separating and allocating each pixels of the input image based on the RGB signal into a character region, a halftone region, and a photograph region. Based on the result of the separation, the segmentation process section 55 produces and dispatches a segmentation class signal indicative of the region assigned with each pixel to a black generation and under color removal section 58, a spatial filter process section 59, and a tone reproduction process section 61 connected downstream while transferring the signal from the input tone correction section 54 directly to a color correction section 56 connected downstream.

The color correction section 56 is provided for removing color impurity through checking the spectral characteristic of C, M, and Y components including useless absorption component in order to reproduce the colors with high fidelity. The color-corrected RGB signal is then transferred to a scaling section 57. The scaling section 57 is provided for enlargement or reduction of the size of the image in response to an instruction signal received from the operation panel 1.

The black generation and under color removal section 58 is provided for producing a K (black) signal from the color-corrected C, M, and Y components of the primary color signal and subtracting the is K signal from the original C, M, and Y signals to generate a new set of C, M, and Y signals. More particularly, this process generates four, i.e., C, M, Y, and K signals from the three original color signals.

The generation of black signal may be conducted by a skeleton black method. Assuming that the input/output characteristic of a skeleton curve is y=f(x), the input data are C, M, and Y, the output data are C′, M′, Y′, and K′, and the UCR (under color removal) rate is a (where 0<α<1), the process of black generation and under color removal is expressed by the next expressions.

K′=f{min(C,M,Y)}

C′=C−αK′

M′=M−αK′

Y=Y−αK′

The spatial filter process section 59 is provided for subjecting the C, M, Y, and K signals of image data received from the black generation and under color removal section 58 to a spatial filtering process with the use of a digital filter based on the segmentation class signal thus to correct the spatial frequency characteristic for eliminating any blur or granular deterioration in the output image.

For example, when the image is separated into the character region by the segmentation process section 55, for improving the reproducibility of achromatic text or chromatic text, the data thereof is subjected to the spatial filtering process performed by the spatial filter process section 59 for sharpening or increasing the degree of enhancement for high frequencies. This is followed by the tone reproduction process section 61 performing a binarization or a multivaluing process with a high-resolution screen suitable for reproduction of the high frequencies. When the image is separated into the halftone region by the segmentation process section 55, the data thereof is subjected to a low-pass filtering process in the spatial filter process section 59 for extracting input halftone components. This is followed by an output tone correcting process by the output tone correction section 60 for converting a signal such as a density signal to a halftone area rate signal which represents a characteristic of a color image display apparatus and then a gradation reproducing process by the tone reproduction process section 61 for finally separating the image into pixels to reproduce respective gray level thereof. When the image is separated into the photograph region by the segmentation process section 55, the data thereof is subjected to the binarization or multivaluing process with a screen specified for reproduction of the gradation.

The image data on which the above described processes have been performed is temporarily stored in a memory means (not shown) and read out from the same at a desired timing and transferred to the image output apparatus 7.

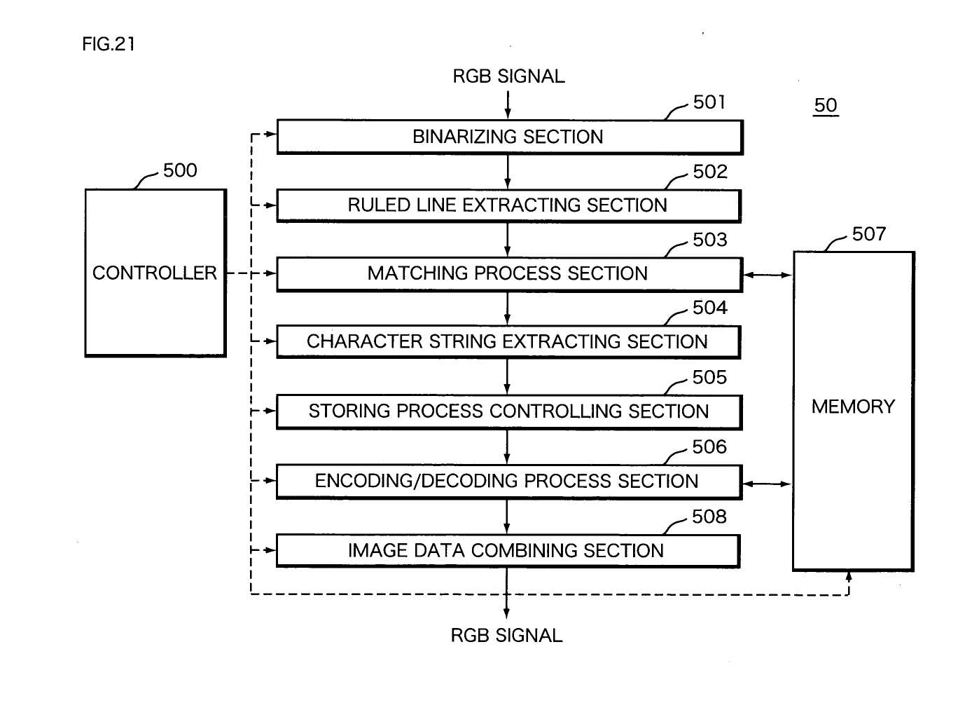

FIG. 21 is a block diagram showing an internal arrangement of the filing process section 50. The filing process section 50 includes a controller 500, a binarizing section 501, a ruled line extracting section 502, a matching process section 503, a character string extracting section 504, a storing process controlling section 505, a encoding/decoding process section 506, a memory 507, and an image data combining section 508.

The controller 500 may be a CPU for controlling the processing of each unit of hardware described above.

The binarizing section 501 is provided for producing a binary input image from the input image. More specifically, the input image of the RGB signal is converted into a monochrome image. This converting process may be carried out by the next expression.

L=0.299×R+0.587×G+0.114×B

The binary input image used in the ruled line extracting section 502 and subsequent units is produced from the monochrome image produced by the converting process. An exemplary process of producing the binary input image will be described. As one line in the input image is selected as a current line to be binarized, the pixels thereof are divided into groups. The pixels divided in the groups determine a mask size. When the pixels in each group are 128, the mask size is expressed as 128 pixels by 128 lines. Then, the average in the mask size is calculated for determining a threshold to be used for the binarizing process. The binarizing process is conducted through comparing the pixels along the current line with the threshold, thus producing a binary form of the input image.

The ruled line extracting section 502 is provided for extracting the ruled line from the image data scanned and producing an image of the ruled line. The process of extracting the ruled line may be implemented by a method disclosed in Japanese Patent Application Laid-Open No. 1-214934. The disclosed method includes separating the image data into strips of a predetermined width and projecting each strip in the vertical direction. A portion of the ruled line is then extracted from the projected data. After such data is extracted from each strip, a candidate which overlaps with a candidate of interest at the largest extension is selected from a neighboring strip and they are connected with each other as a candidate of the same ruled line. By repeating, throughout the strips, this process of determining the candidate which overlaps with the connected candidates at the largest extension from the neighboring strip, a group of the connected candidates which may constitute the same ruled line is determined. As the projection in the horizontal direction of the group of connected candidates is defined as a partial projection which is at a right angle to the projection of the strips in the vertical direction, the coordinates at both ends of the ruled line is determined to obtain the ruled line. As a group of the ruled lines thus obtained is joined or combined together, the final group of the ruled lines is determined. Not only the horizontal ruled line but also the vertical ruled line can be extracted in the same manner.

The matching process section 503 is provided for comparing the input image of the ruled lines with the specific format which has been stored. When the specific format has been stored, a form ID set for each stored format is obtained. When the specific format is not stored, the data of the ruled lines is assigned as a specific format to be stored and a new form ID is set therefor.

The action of collating the specific format may be implemented by a method disclosed in Japanese Patent Application Laid-Open No. 8-255236. The disclose method includes raster scanning and edge extracting the image of ruled lines to detect the start point of tracing in contour definition and tracing a closed curve of the boundary of the figure clockwise or counter-clockwise from the start point. The contour data determined by tracing the closed curve is then stored as a coordinate point string. Using the contour data, the feature points in the image including intersections and corners are determined, and a frame is determined from a combination of the point strings. Then, a circumscribed figure of the input frame data is calculated.

Next, the coordinates at the center point in each frame are calculated. It is assumed that the coordinates at the four corners of the frame are expressed by, from the lower left, (x0, y0), (x1, y1), (x2, y2), and (x3, y3) while the intersection of the two diagonal lines is at (cx, cy). A difference between the coordinates at the upper left and the coordinates at the upper left in the input image is denoted by (dx, dy), and the coordinates at the center point in the frame in either the stored format or the input image of the ruled lines are corrected. The frame data is then correlated between the image and the format. For example, when the coordinates at the center in the frame in the stored format and in the image of the ruled lines are denoted by (tcx, tcy) and (icx, icy) respectively, the distance D is calculated by

D=(icx−tcx)²+(icy−tcy)²

The voting on similarity is performed when the frame is found corresponding to the frame in the stored format (D<dth, dth being the threshold of the distance). When the voting is completed for all the frames in the stored format, the division by n (the number of frames) is performed. More particularly, the similarity is determined by the number of corresponding frames/the number of frames in the ledger sheet. It is then determined from the similarity whether the image of the ruled lines is stored as a specific format.

The character string extracting section 504 is provided for producing an image of characters from the binary input image and the image of the ruled lines. The process of extracting the character string may be implemented by a technique of determining an exclusive OR of the binary input image and the image of the ruled lines extracted by the ruled line extracting section 502. Since the exclusive OR is calculated, not the common ruled lines present in both the binary input image and the image of the ruled lines but the characters can be extracted.

The storing process controlling section 505 is provided for determining whether or not the ruled line image is stored in the memory 507 and correlating the image of characters with a specific format. When the image of the ruled lines extracted by the ruled line extracting section 502 is of the specific format, the storing process controlling section 505 does not permit saving of the image of the ruled lines extracted. Meanwhile, the image of the characters extracted by the character string extracting section 504 is correlated with the specific format and stored in the memory 507.

Alternatively, when the image of the ruled lines extracted by the ruled line extracting section 502 is not of the specific format, the storing process controlling section 505 permits the image of the ruled lines extracted to be stored in relation to another specific format. The image of the ruled lines is assigned with a form ID and then stored in the memory 507. Simultaneously, the image of the characters extracted by the character string extracting section 504 is assigned with another specific format of the ruled lines and stored in the memory 507.

The encoding/decoding process section 506 is provided for encoding the image data to be stored in the memory 507 and decoding the images of the ruled lines and characters in the encoded form retrieved from the memory 507. More particularly, when determined by the storing process controlling section 505 to be stored in the memory 507, the images of the ruled lines and characters are encoded and stored in the memory 507. The method of encoding may be selected from MH, MR, and MMR techniques. The image of the ruled lines and the image of the characters may be encoded separately by different encoding methods.

The method of decoding the images of the ruled lines and characters stored in the encoded form is the reverse of the encoding method. Although both the image of the ruled lines and the image of the characters are subjected to the encoding in this embodiment, one of them may be encoded.

The controller 500 controls the processing of reading the images of the ruled lines and characters of the specific format stored separately in the memory 507. For, e.g., producing a ledger sheet from the image data stored in the memory 507, a group of the character images are read and displayed on the operation panel 1 for allowing the user to select a desired one of the images. Then, the form ID associated with the selected image is retrieved for reading the ruled lines and characters of the selected image from the memory 507. The image of the ruled lines and the image of the characters are transferred to the image data combining section 508.

The images of the characters may be correlated with keywords respectively, and the result of search using the keywords may be displayed in thumbnails or in sequence for selection.

The image data combining section 508 is provided for combing the image of the ruled lines and the image of the characters read out from the memory 507 and outputting the image data (of the RGB signal) formed by combining the same to the document type discrimination section 53. The image data is subjected to the processes in the document type discrimination section 53 to the tone reproduction process section 61 and then transferred to the image output apparatus 7 where it is printed on a sheet of paper to produce the ledger sheet.

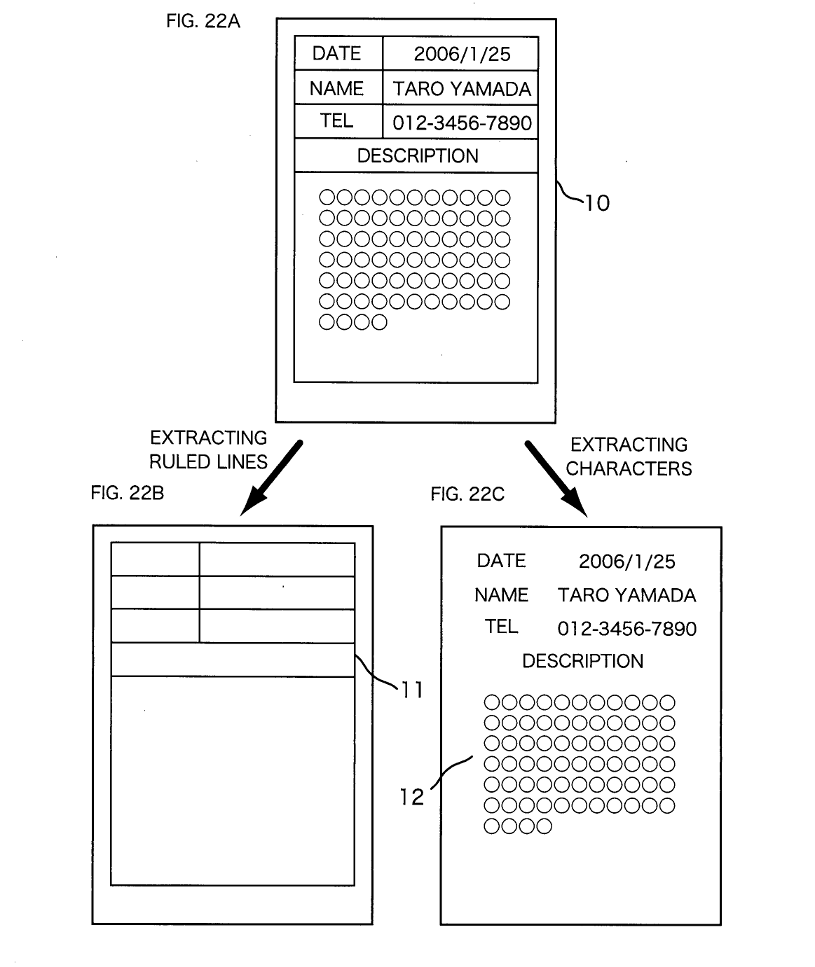

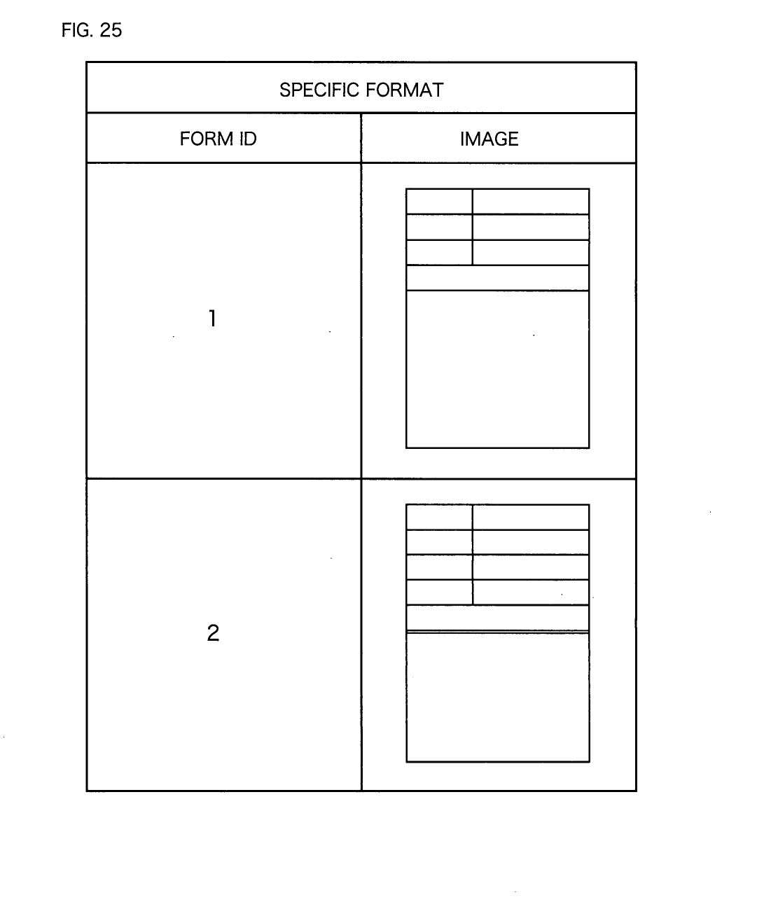

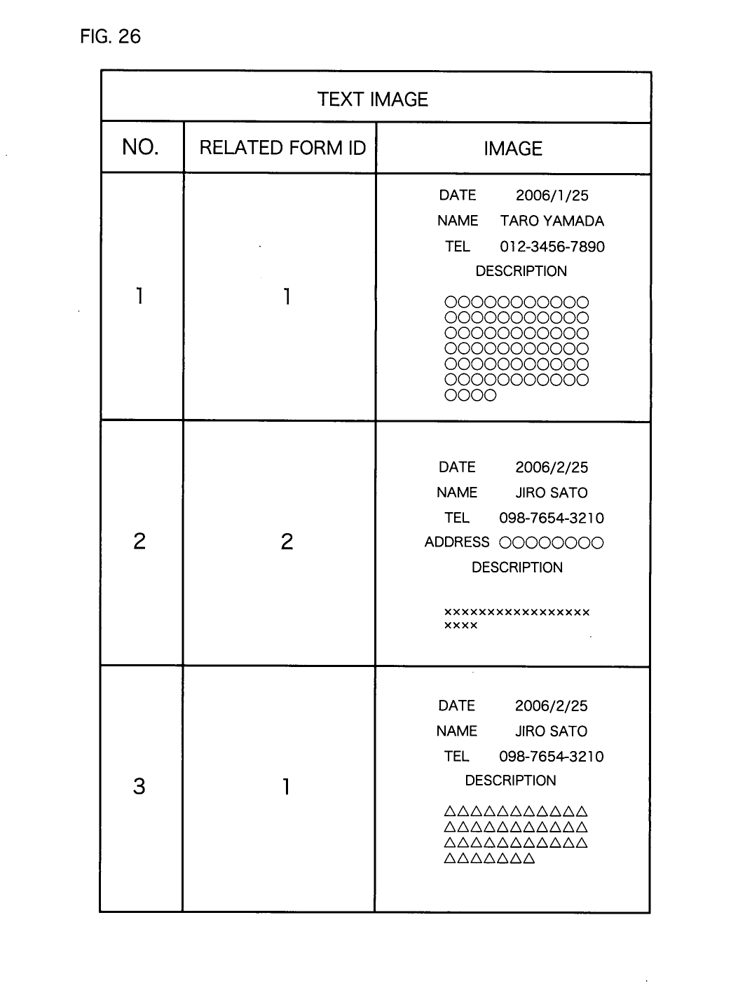

The processes of the image processing system according to this embodiment will be described. FIGS. 22A to 22C, 23A to 23C, and 24A to 24C are schematic views showing the steps of extracting an image of ruled lines and an image of characters. FIG. 25 is a schematic view showing a list of stored images of ruled lines and FIG. 26 is a schematic view showing a list of stored images of characters. When the image of a ledger sheet 10 shown in FIG. 22A is entered from the image input apparatus 3, the filing process section 50 in the image processing apparatus 5 extracts the image of ruled lines 11 (FIG. 22B) and the image of characters 12 (FIG. 22C) from the input image through the technique described above. In the case where the image of the ruled lines 11 extracted is not stored as a specific format, it is assigned with a new form ID and stored in the memory 507. In the list of stored images shown in FIG. 25, the image of the ruled lines 11 is assigned with a form ID “1” and stored as the specific format. Simultaneously, the image of the characters 12 extracted from the ledger sheet 10 is associated with the form ID of the image of the ruled lines 11 and stored in the memory 507. As shown in the list of stored images of FIG. 26, the image of the characters 12 is assigned with the same form ID “1” as that of the image of the ruled lines 11 to be correlated with the image of the ruled line 11.

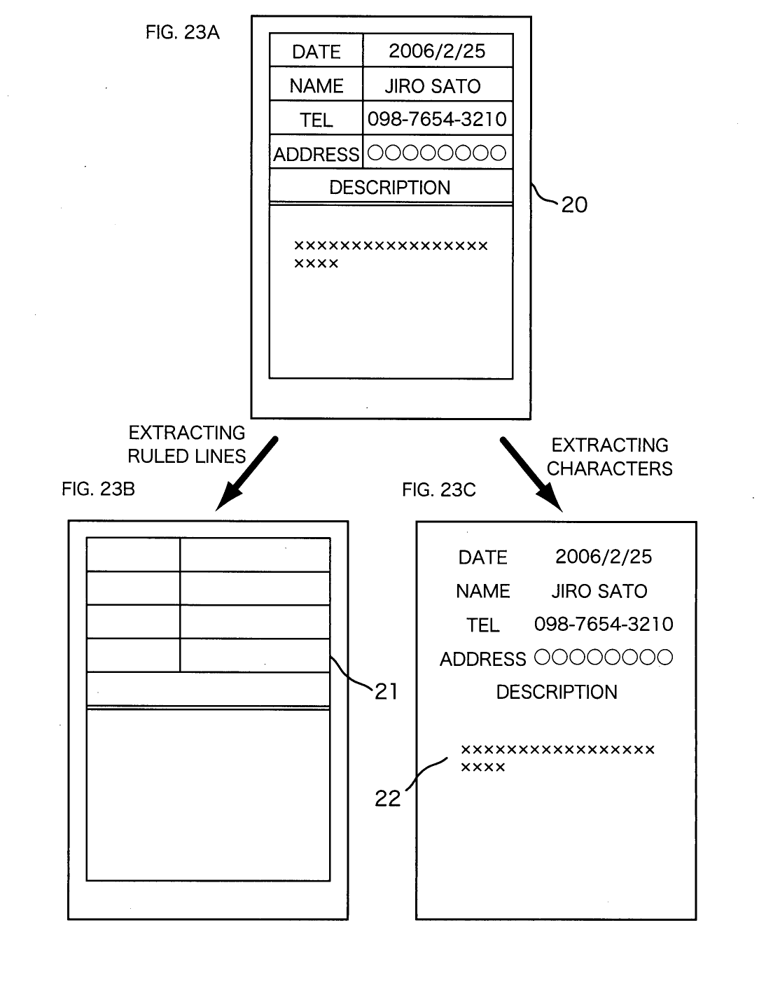

Similarly, when the image of another ledger sheet 20 shown in FIG. 23A is entered from the image input apparatus 3, the filing process section 50 in the image processing apparatus 5 extracts the image of ruled lines 21 (FIG. 23B) and the image of characters 22 (FIG. 23C) from the input image through the technique described above. In the case where the extracted image of the ruled lines 21 is not stored as a specific format, it is assigned with a new form ID and stored in the memory 507. In the list of the stored images shown in FIG. 25, the image of the ruled lines 21 is assigned with a form ID “2” and stored as the specific format. Simultaneously, the image of the characters 22 extracted from the ledger sheet 20 is associated with the form ID of the image of the ruled lines 21 and stored in the memory 507. As shown in the list of the stored images of FIG. 26, the image of the characters 22 is assigned with the same form ID “2” as that of the image of the ruled lines 21 to be correlated with the image of the ruled lines 21.

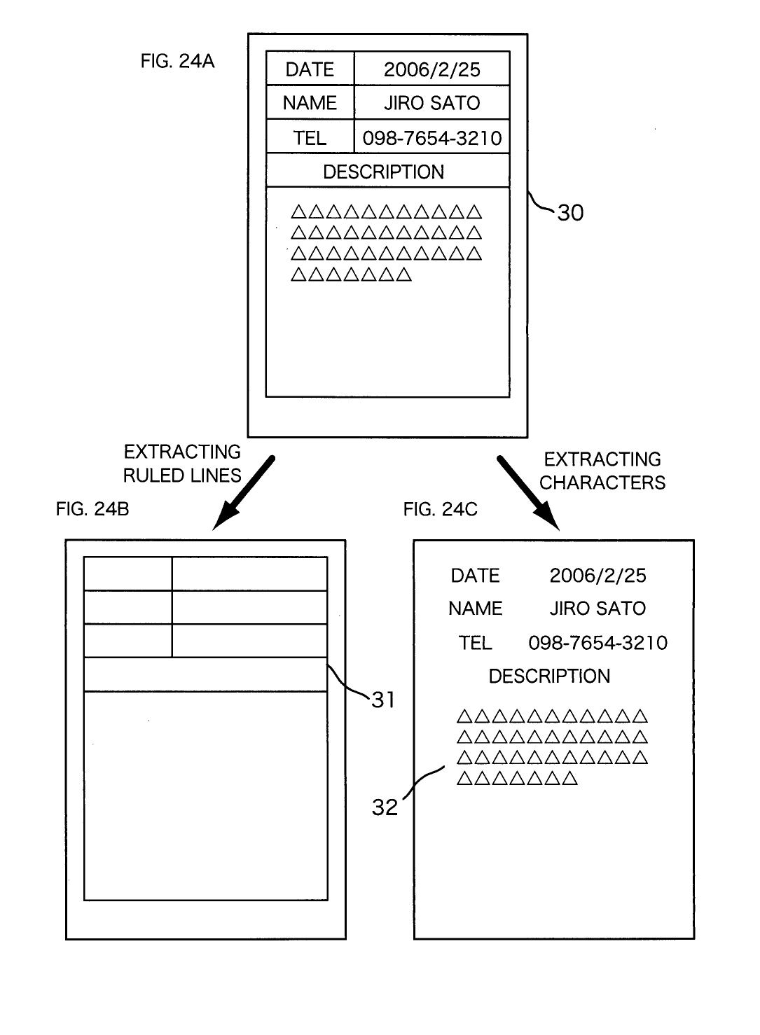

Furthermore, when the image of a further ledger sheet 30 shown in FIG. 24A is entered from the image input apparatus 3, the filing process section 50 in the image processing apparatus 5 extracts the image of ruled lines 31 (FIG. 24B) and the image of characters 32 (FIG. 24C) from the input image through the technique described above. Since the format of the image of the ruled lines 31 is identical to the specific format assigned with the form ID “1”, it does not need to be assigned with a new form ID and the form ID “1” assigned to the specific format is acquired. The image of the characters 32 extracted from the ledger sheet 30 is also associated with the form ID of the image of the ruled lines 31 and stored in the memory 507. As shown in the list of the stored images of FIG. 26, the image of the characters 32 is assigned with the same form ID “1” as that of the image of the ruled lines 31 to be correlated with the image of the lines 31.

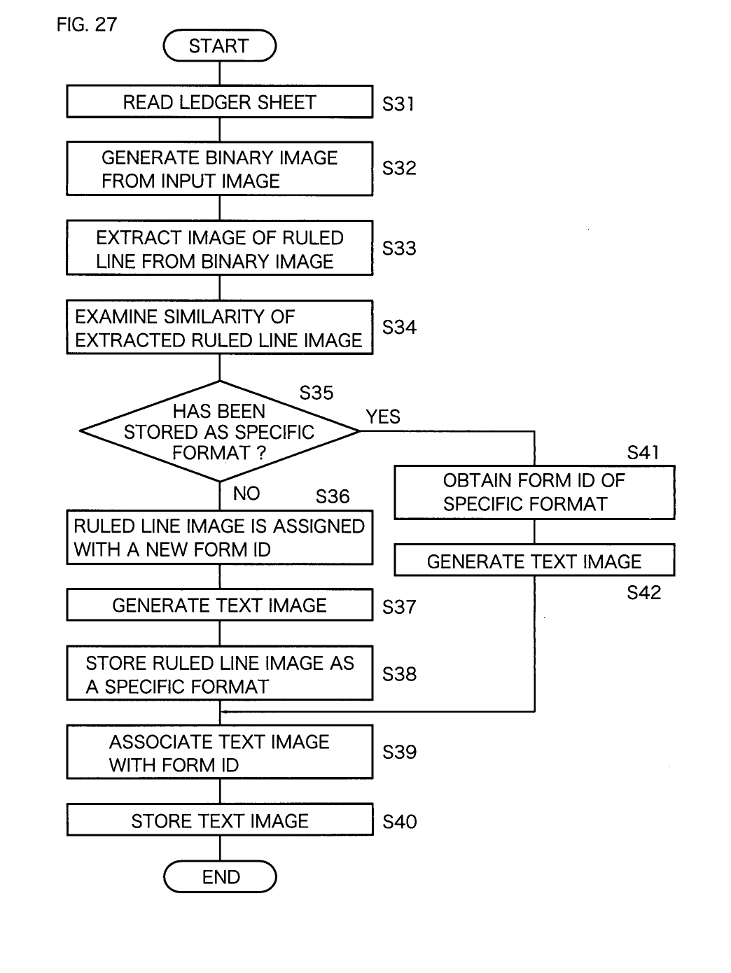

A procedure of carrying out the processes in the image processing system will now be described. FIG. 27 is a flowchart showing the procedure for storing the image of ruled lines and the images of characters. The procedure starts with the image input apparatus 3 reading a ledger sheet of interest (Step S31). The ledger sheet read by the image input apparatus 3 is transferred in the form of an analog RGB signal (input signal) to the image processing apparatus 5.

When received by the image processing apparatus 5, the analog RGB signal is transferred via the AD conversion section 51 and the shading correction section 52 to the filing process section 50. The binarizing section 501 in the filing process section 50 then generates a binary image from the input image (Step S32). The ruled line extracting section 502 extracts an image of ruled lines from the binary image produced by the binarizing section 501 (Step S33).

The matching process section 503 accesses a list of the ruled line images stored in the memory 507 and examines the similarity between the extracted ruled line image and stored ruled images (Step S34). It is then examined whether or not the ruled line image extracted in Step S33 has been stored as a specific format (Step S35).

When it is determined that the ruled line image has not been stored as a specific format (no in Step S35), the ruled line image is assigned with a new form ID (Step S36). The character string extracting section 504 calculates an exclusive OR of the input image and the ruled line image to extract character strings contained in the input image and generate an image of characters, i.e. text image (Step S37).

The storing process controlling section 505 stores the ruled line image assigned with the new form ID as a specific format in the memory 507 (Step S38). More particularly, the ruled line image is stored in the memory 507 after having been encoded by the encoding/decoding process section 506.

Also, the storing process controlling section 505 assigns the character image with a form ID corresponding to the form ID assigned to the ruled line image for correlating the ruled line image with the text image (Step S39). The text image is encoded by the encoding/decoding process section 506 and stored in memory 507 (Step S40).

On the other hand, when it is determined that the ruled line image extracted has been stored as a specific format (yes in Step S35), the form ID assigned to the specific format is obtained (Step S41). The character string extracting section 504 calculates an exclusive OR of the input image and the ruled line image to extract character strings contained in the input image and generate a text image (Step S42).

The storing process controlling section 505 assigns the character image with a form ID corresponding to the form ID assigned to the ruled line image for correlating the ruled line image with the text image (Step S39). The text image is encoded by the encoding/decoding process section 506 and stored in the memory 507 (Step S40).

### Third Embodiment

Although each of the processes is carried out with hardware according to both the first and second embodiments, it may be conducted by a computer that executes a set of computer programs (including an execution program, an intermediate code program, and a source program).

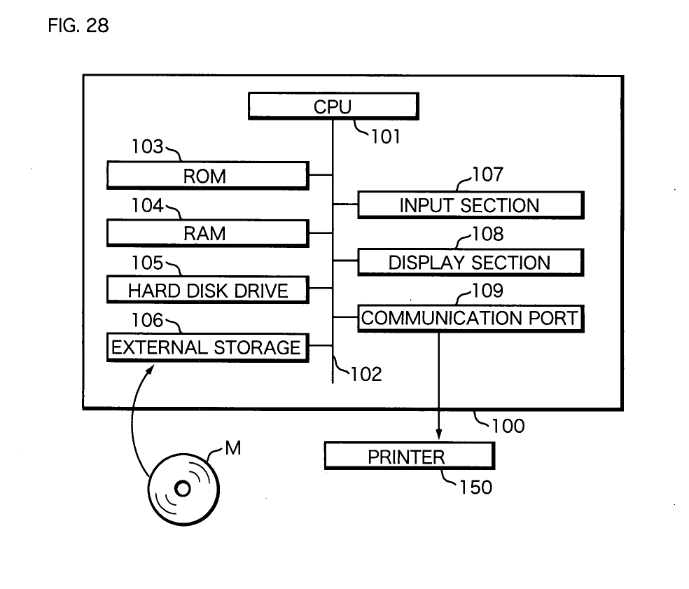

FIG. 28 is a block diagram illustrating an internal arrangement of the image processing apparatus in which the above described computer programs are installed for executing the processes. Denoted by reference numeral 100 in the figure is the image processing apparatus according to the present embodiment. More specifically, the image processing apparatus is provided in the form of a personal computer, a workstation and the like. The image processing apparatus 100 includes a CPU 101 which is connected via a bus 102 to a group of hardware components including a ROM 103, a RAM 104, a hard disk drive 105, an external storage 106, an input section 107, a display section 108, and a communication port 109. The CPU 101 is provided for controlling the process of each hardware component with the use of program codes of a control program stored preliminarily in the ROM 103.

The RAM 104 is a volatile memory for temporarily saving the control program and a variety of data produced during the execution of the computer programs for conducting the above described processes. The hard disk drive 105 is a storage unit having a magnetic recording medium where the program codes of the computer program and the like are stored. The external storage 106 includes a reader for reading the program codes from the recording medium M for conducting the above described processes. The recording medium M may be a flexible disk (FD) or a CD-ROM, for example. The program codes read by the external storage 106 are stored in the hard disk drive 105. The CPU 101 loads the RAM 104 with the program codes received from the hard disk drive 105 for use in conducting and controlling the processing of the entire apparatus as described in the first embodiment for correlating the ruled line image with the character image to be stored and storing the two images in the hard disk drive 105.

The input section 107 functions as an interface for receiving the image data from the outside. The input section 107 may thus be connected with a color scanner. The display section 108 functions as an interface for displaying image data to be processed, image data being processed, processed image data, and other data, The display section 108 may be connected with an external display such as a liquid crystal display for displaying the image data. Alternatively, the display section 108 may have a built-in display provided for displaying the image data. The communication port 109 is an interface for communicating with an external printer 150. For printing the processed image data with the printer 150, the image processing apparatus 100 produces from the image data print data to be decoded by the printer 150 and dispatches the same to the printer 150.

Although the various calculations are performed by the CPU 101 in the present embodiment, it may be conducted by a dedicated chip for performing calculation relating to image processing in response to commands from the CPU 101.

The recording medium M for saving the program codes of the computer program is not limited to the floppy disk or CD-ROM but may be selected from optical disks such as an MO, an MD, or a DVD, magnetic recording media such as a hard disk, card-type recording media such as an IC card, a memory card, or an optical card, and semiconductor memories such as a mask ROM, an EPROM (erasable programmable read only memory), an EEPROM (electrically erasable programmable read only memory), or a flash ROM. Also, the system may be connected with communication networks including the Internet for downloading the program codes of the computer program through a desired communication network to carry out the above described processes. Moreover, the program codes to be employed may be received electronically in the form of computer data signals buried in carriers.

The computer program may be provided as a single application program, a utility program, or a part of a composite program consisting of an application program and a utility program.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image processing apparatus comprising:
an image input section for inputting of an image;
an image storing section for storing images; and
a controller capable of performing operations of
determining a similarity between an input image inputted from the image input section and a stored image stored in the image storing section;
determining whether or not the input image is equivalent to an image included an additional writing to the stored image, when it is determined that the input image is similar to the stored image;
extracting a region containing the additional writing from the input image, when it is determined that the input image is equivalent to the image included the additional writing to the stored image; and
storing an image of the extracted region in the image storing section.

2. The image processing apparatus according to claim 1, wherein
said controller is capable of storing images included in the extracted regions respectively in the image storing section, when a plurality of the regions have been extracted.

3. The image processing apparatus according to claim 1, wherein
said controller is further capable of encoding the image to be stored in the image storing section.

4. The image processing apparatus according to claim 3, wherein
said controller is further capable of operations of
decoding the encoded images stored in the image storing section; and
combining the decoded images.

5. An image processing apparatus comprising:
an image input section for inputting of an image; and
a controller capable of performing operations of:
extracting ruled lines and characters separately from the input image inputted from the image input section;
determining whether or not a format of the extracted ruled lines is a predetermined format;
storing the extracted characters in a storing section in association with the ruled lines having the predetermined format, when it is determined that the format of the extracted ruled lines is the predetermined format; and
storing the extracted ruled lines in the storing section, when it is determined that the format of the extracted ruled lines is not the predetermined format.

6. The image processing apparatus according to claim 5, wherein
said controller is further capable of storing the extracted characters in the storing section in association with the ruled lines, when it is determined that the format of the extracted ruled lines is not the predetermined format.

7. The image processing apparatus according to claim 6, wherein
said controller is further capable of performing operations of:
encoding the extracted ruled lines and characters; and
storing the encoded ruled lines and characters in the storing section.

8. The image processing apparatus according to claim 7, wherein
said controller is further capable of operations of:
decoding the encoded ruled lines and characters stored in the storing section; and
combining the decoded lines and characters.

9. An image processing apparatus comprising:
an image input section for inputting of an image;
an image storing section for storing images;
a similarity determining section for determining a similarity between an input image inputted from the image input section and a stored image stored in the image storing section; and
a region extracting section for determining whether or not the input image is equivalent to an image included an additional writing to the stored image when it is determined that the input image is similar to the stored image and extracting a region containing the additional writing from the input image; wherein
an image of the region extracted by the region extracting section is stored in the image storing section.

10. An image processing apparatus comprising:
an image input section for inputting of an image;
an extracting section for extracting ruled lines and characters separately from the input image inputted from the image input section; and
a determining section for determining whether or not a format of the extracted ruled from the extracting section is the predetermined format, wherein
the extracted characters are stored in a storing section in association with the ruled lines having the predetermined format, when it is determined that the format of the extracted ruled lines is the predetermined format; and
the extracted ruled lines are stored in the storing section, when it is determined that the format of the extracted ruled lines is not the predetermined format.

11. An image reading apparatus comprising:
an image reading section for reading an image from a document; and
the image processing apparatus according to claim 1, wherein
the image read by the image reading section is processed in the image processing apparatus.

12. An image reading apparatus comprising:
an image reading section for reading an image from a document; and
the image processing apparatus according to claim 5, wherein
the image read by the image reading section is processed in the image processing apparatus.

13. An image reading apparatus comprising:
an image reading section for reading an image from a document; and
the image processing apparatus according to claim 9, wherein
the image read by the image reading section is processed in the image processing apparatus.

14. An image reading apparatus comprising:
an image reading section for reading an image from a document; and
the image processing apparatus according to claim 10, wherein
the image read by the image reading section is processed in the image processing apparatus.

15. An image forming apparatus comprising:
the image processing apparatus according to claim 4; and
an image forming section for forming a combined image by the image processing apparatus on a sheet.

16. An image forming apparatus comprising:
the image processing apparatus according to claim 8; and
an image forming section for forming a combined image by the image processing apparatus on a sheet.

17. A method of processing images, comprising the steps of
determining a similarity between an input image and a stored image;
determining whether or not the input image is equivalent to an image included an additional writing to the stored image, when it is determined that the input image is similar to the stored image;
extracting a region containing the additional writing from the input image, when it is determined that the input image is equivalent to the image included the additional writing to the stored image; and
storing an image of the extracted region in the storage.

18. A method of processing images, comprising the steps of:
extracting ruled lines and characters separately from an input image;
determining whether or not a format of the extracted ruled lines is a predetermined format;
storing the extracted characters in a storage in association with the ruled lines having the predetermined format, when it is determined that the format of the extracted ruled lines is the predetermined format; and
storing the extracted ruled lines in the storage, when it is determined that the format of the extracted ruled lines is not the predetermined format.

19. A recording medium storing thereon a computer program executable to perform the steps of:
determining a similarity between an input image and a stored image;
determining whether or not the input image is equivalent to an image included an additional writing to the stored image, when it is determined that the input image is similar to the stored image;
extracting a region containing the additional writing from the input image, when it is determined that the input image is equivalent to the image included the additional writing to the stored image; and
storing an image of the extracted region in the storage.

20. A recording medium storing thereon a computer program executable to perform the steps of:
extracting ruled lines and characters separately from an input image;
determining whether or not a format of the extracted ruled lines is a predetermined format;
storing the extracted characters in a storage in association with the ruled lines having the predetermined format, when it is determined that the format of the extracted ruled lines is the predetermined format; and
storing the extracted ruled lines in the storage, when it is determined that the format of the extracted ruled lines is not the predetermined format.
